(19) United States
(12) Patent Application Publication
(10) Pub. No.: US 2026/0288884 A1
(43) Pub. Date: Sep. 24, 2026

(54) SYSTEM

(71) Applicant: SoftBank Group Corp., Tokyo (JP)

(72) Inventor: Mihoko HIRAYAMA, Tokyo (JP)

(73) Assignee: SoftBank Group Corp., Tokyo (JP)

(21) Appl. No.: 19/567,307

(22) Filed: Mar. 16, 2026

(30) Foreign Application Priority Data
Mar. 19, 2025 (JP) 2025-045110

(51) Int. Cl. G06F 16/9535; G06F 40/20

(52) U.S. Cl. CPC G06F 16/9535; G06F 40/20

(57) ABSTRACT

A system includes a processor that is configured to provide an interface for receiving a specific request from a user, analyze the received request and generate a prompt for instructing a generative AI model to perform a recommendation of subculture content, and input the prompt to the generative AI model to generate a recommendation result.

### CROSS-REFERENCE TO RELATED APPLICATION

This application is based on and claims priority under 35 USC 119 from Japanese Patent Application No. 2025-045110 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional recommendation systems generally rely on predefined rules or statistical models that process structured user data, such as past purchase history or explicit ratings. Such systems often cannot effectively interpret free-form, natural language input that expresses a user's concrete request, nuanced preference, or personal concern. As a result, these systems are unable to flexibly generate recommendations that closely match a user's specific and context-dependent needs, particularly in domains such as subculture content, music, and books related to personal concerns. Furthermore, when a generative AI model is used, there is no standardized mechanism for systematically generating prompts from user requests in a way that reliably induces the generative AI model to output recommendation results that correspond to the user's intentions. Accordingly, there is a need for a system that can receive a specific request expressed in natural language from a user, automatically generate a suitable prompt for a generative AI model on the basis of the request, and cause the generative AI model to generate high-quality recommendation results for subculture content, including music and books related to user concerns.

### SUMMARY

In order to solve the above-described problem, an embodiment of the present invention provides a system comprising a processor, wherein the processor is configured to provide an interface for receiving a specific request from a user, analyze the received request and generate a prompt for instructing a generative AI model to perform a recommendation of subculture content, and input the prompt to the generative AI model to generate a recommendation result. In one aspect, the processor is further configured to analyze data regarding a music preference of the user, such as genre preference, mood, tempo, or usage scene, and generate a prompt for instructing the generative AI model to perform a recommendation of music that reflects such analyzed preference data. In another aspect, the processor is further configured to analyze information regarding a concern of the user, such as a problem in workplace human relationships or personal life, and generate a prompt for instructing the generative AI model to perform a recommendation of a related book that provides information or guidance relevant to the concern. By generating prompts adapted to the type and content of the user's request and by inputting such prompts to the generative AI model, the system enables the flexible and accurate generation of recommendation results that are closely aligned with the user's specific needs.

The term “system” refers to an apparatus or collection of one or more devices, including at least one processor and associated hardware and/or software components, that collectively perform the functions described in the claims.

The term “processor” refers to any hardware device or combination of hardware and software configured to execute instructions, including but not limited to a central processing unit (CPU), a graphics processing unit (GPU), a microcontroller, or a specialized processing circuit.

The term “interface” refers to a hardware and/or software component that enables input and/or output between the user and the system, and includes, for example, graphical user interfaces, web pages, application screens, voice interfaces, or APIs that accept user input.

The term “user” refers to a human operator who interacts with the system through the interface to provide requests or other information and to receive recommendation results.

The term “specific request” refers to a user's explicitly expressed desire, preference, or requirement, typically provided as natural language input, that indicates the type of content or recommendation the user is seeking.

The term “subculture content” refers to content associated with specific cultural or hobbyist communities, including but not limited to anime, manga, games, music, and related media or derivative works.

The term “music preference” refers to information indicating a user's likes or tendencies regarding music, including but not limited to favored genres, artists, moods, tempos, eras, or usage scenes.

The term “concern of the user” refers to an issue, problem, worry, or interest expressed by the user, including but not limited to personal, social, work-related, or psychological matters for which the user seeks information or guidance.

The term “book” refers to any work of written content, including printed books, electronic books (e-books), or other text-based publications, that can be recommended to address or relate to the user's concern.

The term “generative AI model” refers to an artificial intelligence model configured to generate output content, such as text, recommendations, or other data, in response to an input, and includes but is not limited to large language models and other machine learning models capable of content generation.

The term “prompt” refers to data generated by the processor and provided as input to the generative AI model, the data including instructions, context, and/or user-related information that cause the generative AI model to produce a recommendation result.

The term “recommendation result” refers to output generated by the generative AI model in response to a prompt, the output including one or more candidate items of subculture content, music, or books, or related information indicating which items are recommended to the user.

The term “analyze” refers to processing, interpreting, or extracting information from input data, such as the user's specific request, music preference data, or concern information, using any combination of parsing, natural language processing, pattern recognition, or other computational techniques.

The term “instructing” refers to causing or directing the generative AI model, via a prompt or other input data, to perform a specified operation, such as generating a recommendation of subculture content, music, or books.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

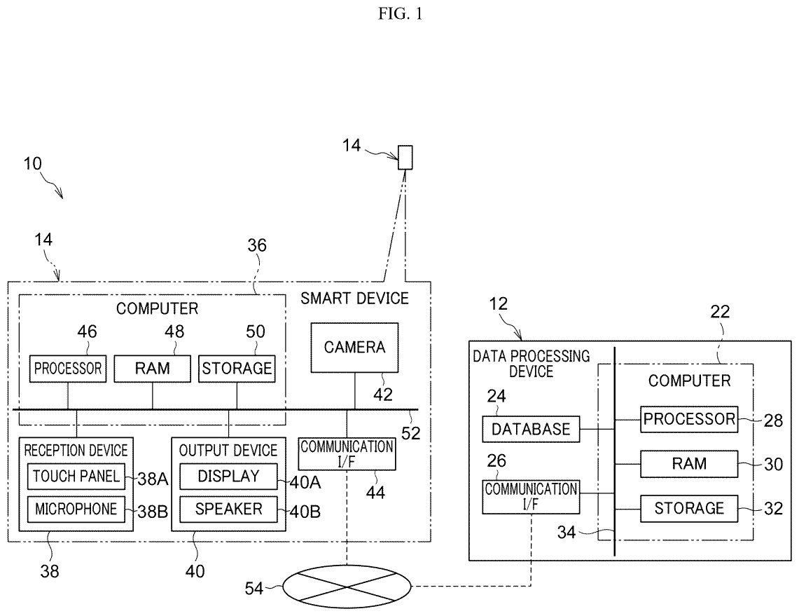

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

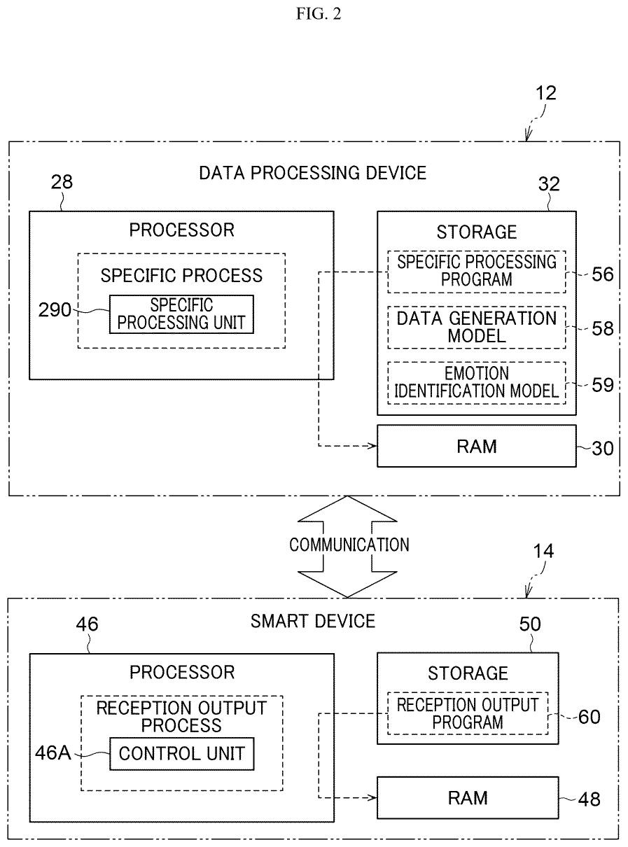

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented recommendation systems typically rely on manually designed rule sets, fixed attribute filters, or simple collaborative filtering based on historical user behavior. Such systems often require extensive feature engineering and repeated manual tuning by developers, and they exhibit limited flexibility when handling free-form natural language requests from users. When a user expresses a concrete but nuanced request in natural language, existing systems frequently fail to convert the request into machine-interpretable parameters in a consistent and scalable manner. As a result, the system cannot fully utilize diverse content catalogs or external information sources and tends to return generic or irrelevant recommendations.

Moreover, in conventional architectures, any incorporation of a generative AI model is often performed in an ad hoc fashion: developers manually craft prompts for each use case, and the system has no standardized mechanism to extract structured attributes from user input, construct optimized prompt sentences, and post-process generated text into actionable recommendation items with machine-resolvable identifiers and access links. This leads to inefficiencies in computation, increased latency, and difficulty in guaranteeing the reliability and traceability of the recommendation pipeline. It also impedes systematic improvement of the underlying computer system, because the generative AI model is treated as a black-box text generator rather than as an integrated computational component of the recommendation architecture.

In addition, existing systems often lack a robust computational process to bridge between unstructured model outputs and external content provider systems. Even when a generative AI model outputs a plausible list of recommended items, the system has no reliable mechanism to parse those outputs, resolve them against external data sources, and generate purchase-ready or usage-ready access information in a consistent format. This results in additional manual work, increased processing overhead, and unstable user experiences, thereby limiting the technical performance and scalability of the overall computer system.

Accordingly, there is a need for an improved computer-implemented recommendation architecture that can: (i) automatically analyze concrete natural language requests from users; (ii) generate standardized, machine-optimized prompt sentences for a generative AI model; (iii) efficiently integrate the generative AI model's output with external information provider systems; and (iv) generate structured recommendation result information including connection information that directly enables acquisition or use of recommended items. By addressing these needs, the invention aims to improve the functioning of the computer system itself, including data processing efficiency, adaptability to diverse content domains, traceable integration of AI-generated results, and overall reliability of recommendation delivery.

The specific processing by the specific processing unit 290 of the data processing device 12 in Example 1 is realized by the following means.

The present invention provides a server comprising a processor configured to provide, on an information processing apparatus, an input/output screen serving as an interface for obtaining a concrete request from a user and acquire the request as character information input through the input/output screen; analyze the acquired character information by using a natural language processing algorithm to generate abstract attribute information indicating a target domain, preference attributes, and constraint conditions included in the request; construct, on the basis of the abstract attribute information, a prompt sentence that defines instruction content, an output format, and a number of recommendations for a generative AI model; execute communication processing for inputting the constructed prompt sentence to the generative AI model and receive response text regarding candidate recommendations from the generative AI model; analyze the received response text to extract name information and creator information of each candidate recommendation; obtain, by collating an extraction result with a response result from an external information providing apparatus, identification information and reference location information corresponding to each candidate recommendation; and generate recommendation result information including connection information that enables the user to acquire or use the candidate recommendations on the basis of the identification information and the reference location information, and present the recommendation result information to the user via the input/output screen. This enables the computer system to automatically transform unstructured natural language requests into structured prompt sentences, efficiently utilize a generative AI model within a controlled and traceable processing pipeline, resolve AI-generated recommendations against external data sources to obtain machine-usable identifiers and access locations, and output structured, purchase-ready or usage-ready recommendation results, thereby improving the technical performance, scalability, and reliability of the recommendation processing executed by the server.

The term “system” refers to an arrangement of one or more information processing apparatuses and one or more processors, executing cooperative processing to obtain user requests, interact with a generative AI model, access external information sources, and provide recommendation results to a user.

The term “processor” refers to a hardware computation unit or a combination of hardware computation units, such as a central processing unit or a graphics processing unit, configured to execute instructions for implementing the functions described in the claims.

The term “information processing apparatus” refers to an electronic device having at least a processor, a memory, and an input/output interface, such as a general-purpose computer, a mobile device, or a display terminal, on which a user interface is presented and through which a user interacts with the system.

The term “input/output screen” refers to a user interface presented on a display unit of the information processing apparatus, including one or more areas for inputting information and one or more areas for presenting information, and serving as an interface between the user and the system.

The term “user” refers to a human operator or an entity that provides a request to the system through the input/output screen and receives recommendation results from the system.

The term “concrete request” refers to a user's specific expression of desired content or information, including at least one constraint or preference described in natural language or equivalent character information.

The term “character information” refers to digital data representing textual content, including letters, symbols, numerals, and punctuation, obtained from user input via the input/output screen.

The term “natural language processing algorithm” refers to a software-implemented procedure executed by the processor to analyze character information expressed in a human language, including at least one of tokenization, part-of-speech tagging, entity extraction, classification, or semantic interpretation.

The term “abstract attribute information” refers to structured data generated from the concrete request, representing generalized properties such as a target domain, preference attributes, and constraint conditions, and being suitable for programmatic processing and prompt construction.

The term “target domain” refers to a category of content or information, such as audio content, video content, text content, or other media content, to which the recommendation is directed.

The term “preference attributes” refers to structured parameters derived from the user's request that express the user's likes or desired characteristics, including at least one of genre, mood, style, theme, usage scene, or time period.

The term “constraint conditions” refers to structured parameters derived from the user's request that limit or qualify the recommendations, including at least one of availability conditions, platform constraints, language constraints, region constraints, or content-type constraints.

The term “prompt sentence” refers to a sequence of character information constructed on the basis of abstract attribute information, defining instruction content, an output format, and a number of recommendations for input to a generative AI model.

The term “instruction content” refers to a description included in the prompt sentence that specifies a task to be performed by the generative AI model, such as recommending items, describing properties, or outputting in a particular structure.

The term “output format” refers to a specification included in the prompt sentence that indicates a desired structure or representation of the generative AI model's response, such as list form, tabular form, or a structured data format.

The term “number of recommendations” refers to a quantity indicator included in the prompt sentence that specifies how many recommendation items the generative AI model is requested to output.

The term “generative AI model” refers to a machine-learned model that, given input text such as a prompt sentence, generates output text or structured data by predicting tokens or symbols based on trained parameters.

The term “communication processing” refers to a sequence of operations executed by the processor to transmit the prompt sentence to the generative AI model and to receive response text, including network protocol handling, encryption, and error handling.

The term “response text” refers to character information returned from the generative AI model in response to the prompt sentence, including descriptions of candidate recommendations and associated data.

The term “candidate recommendation” refers to an item or entity proposed by the generative AI model as relevant to the user's request, such as a piece of content, a media work, or a document.

The term “name information” refers to textual data extracted from the response text that identifies a candidate recommendation by title, designation, or label.

The term “creator information” refers to textual data extracted from the response text that identifies an originator, author, artist, or producer associated with a candidate recommendation.

The term “external information providing apparatus” refers to a system or service external to the system of the invention, accessible via a communication network, and configured to provide information such as catalog data, identifiers, or access locations for content items.

The term “extraction result” refers to structured data output from analysis of the response text, including at least name information and creator information for each candidate recommendation.

The term “response result” refers to information obtained from the external information providing apparatus in response to a query including at least part of the extraction result.

The term “identification information” refers to machine-resolvable data, such as a content identifier, record key, or unique reference code, associated with a candidate recommendation and obtained by collating the extraction result with the response result.

The term “reference location information” refers to information specifying a location at which a candidate recommendation can be accessed, such as a network address, resource locator, or equivalent location designator.

The term “connection information” refers to data derived from the identification information and the reference location information that enables the user or the information processing apparatus to establish access to a candidate recommendation, such as a link, a deep link, or an access token.

The term “recommendation result information” refers to structured data generated by the processor that includes, for one or more candidate recommendations, at least the connection information and optionally further descriptive information, and is suitable for presentation to the user via the input/output screen.

The term “audio content” refers to content primarily composed of sound, including at least music data, spoken-word data, or other sound recordings.

The term “document content” refers to content primarily composed of text, including at least books, articles, reports, or other written materials.

The term “usage scene” refers to a contextual situation in which recommended content is intended to be used, such as studying, exercising, relaxing, commuting, or working.

The term “usage medium” refers to a category of platform or device through which content is consumed, such as a streaming service, a download service, or a physical playback device.

The term “psychological state” refers to information indicating a user's emotional, mental, or affective condition as expressed in a request, such as stress, motivation, relaxation, or concern.

The term “issue” refers to a user's problem, question, concern, or topic requiring information or support, as expressed in the concrete request.

In one embodiment, a server includes at least one processor and a memory, and is connected via a communication network to one or more terminals operated by users and to one or more external information providing systems. The server executes an application program that implements functions for obtaining a concrete request from a user, analyzing the request, generating a prompt sentence for a generative AI model, communicating with the generative AI model, collating AI-generated candidate recommendations with external content catalogues, and generating recommendation result information including connection information that enables the user to acquire or use recommended items.

The server may be implemented on general-purpose hardware such as an x86-based or ARM-based computer equipped with a central processing unit (CPU), volatile memory (RAM), non-volatile storage (for example, a solid-state drive), and a network interface controller. The server may further include one or more graphics processing units (GPUs) for accelerating neural-network inference, such as GPUs conforming to a general-purpose parallel processing architecture. The server may execute an operating system such as a general-purpose server operating system and may run application software developed using a server-side framework, for example a web framework or an application framework. The generative AI model may be deployed on the same server, on a separate computing node within a data center, or on a remote AI service accessible via an application programming interface.

The terminal is an information processing apparatus such as a smartphone, a tablet device, or a personal computer. The terminal includes a processor, a memory, a display, an input device (for example, a touch panel or a keyboard), and a communication interface. The terminal executes a client application, such as a web browser or a native application. The terminal displays an input/output screen provided by the server. The terminal acquires character information entered by the user on the input area of the screen, such as a text field for describing desired content or preferences, and transmits the character information to the server via a communication protocol such as HTTPS.

The user operates the terminal to access a web application or other user interface provided by the server. The user inputs a concrete request in natural language, for example “I want upbeat Japanese pop songs similar to anime opening themes from the 2000s,” “Recommend dark fantasy animation with complex characters similar to Attack on Titan, available for legal streaming,” or “I want energetic vocaloid songs suitable for dancing, with BPM around 140, available on a streaming platform.” The user may optionally specify additional parameters such as preferred platforms, languages, or usage scenes via selectable options on the input/output screen.

The server receives the character information from the terminal and stores the character information and associated metadata in a storage unit using a structured data format. The server may store each request as a record comprising fields such as a request identifier, a user identifier (if available), the original text string of the concrete request, a timestamp, a language code, and an initial content category (if provided by the user).

The server analyzes the acquired character information by executing a natural language processing algorithm. The server may use a natural language processing library or framework that performs tokenization, part-of-speech tagging, and named entity recognition. The server may, for example, convert the request text into a token sequence, detect entities such as artist names, work titles, or genres, and classify the request into a domain (such as audio content, video content, or document content). The server may also detect attributes such as mood, genre, tempo, usage scene, and time period by applying a classification model or pattern-based rules.

In one embodiment, the server uses a transformer-based encoder model as the natural language processing algorithm. The server stores the encoder model parameters in the memory and performs inference by applying the encoder to a sequence of token embeddings generated from the user's request. The server may use multi-head self-attention layers, feed-forward layers, and normalization layers. The server may calculate attention scores for each token based on learned weight matrices, and may aggregate contextualized embeddings to produce a semantic representation of the entire request. The server may then pass this representation through one or more linear layers to predict domain labels, genre labels, or mood categories. The server may also compute similarity scores between the representation and predefined prototype vectors corresponding to abstract attributes, thereby inferring the most likely attributes.

The server generates abstract attribute information from the analysis results. For example, the server may create a data structure that includes fields such as “domain: audio content,” “genre: Japanese pop,” “mood: upbeat,” “usage scene: energizing listening,” “time period: 2000s,” and “platform constraint: legal streaming.” The server stores this abstract attribute information in association with the request record. The server may represent the attributes as key-value pairs, enumerated codes, or vector representations. This data structure is specifically designed to be programmatically processed and to support construction of a prompt sentence.

The server constructs a prompt sentence for a generative AI model using the abstract attribute information. The server may maintain one or more template sentences stored in the memory. A template may include placeholder positions for domain, number of items, and attributes. The server fills in the placeholders based on the abstract attribute information and additional system-level requirements such as desired output format and number of recommendations. Because the abstract attribute information is normalized into a constrained schema, the prompt sentence generation is performed in a consistent and repeatable manner, which improves machine-interpretability and reduces prompt variance across similar requests.

The server may construct prompt sentences such as:

“Based on the following user request, recommend 10 Japanese pop songs that are upbeat and stylistically similar to anime opening themes from the 2000s. For each song, provide the title, artist name, and a short description of why it matches. User request: ‘I want upbeat Japanese pop songs similar to anime opening themes from the 2000s.’ Output in a concise bullet list.”

“Given the following user request, recommend 8 dark fantasy animation series with complex characters, similar in tone and themes to ‘Attack on Titan.’ Only include series that are legally available for streaming on major platforms. For each series, provide the title, a one-sentence plot summary, and which popular streaming platforms carry it. User request: ‘Recommend dark fantasy animation with complex characters similar to Attack on Titan, available for streaming legally.’”

“Based on the following user request, recommend 15 energetic vocaloid songs suitable for dancing, with BPM around 140 (±20), and that are typically available on a major audio streaming service. For each song, provide: title, producer name, approximate BPM, and one short reason why it matches the request. User request: ‘I want energetic vocaloid songs suitable for dancing, with BPM around 140, available on a streaming platform.’ Respond in English and format the output as a clearly separated list.”

By constructing the prompt sentence using abstract attribute information and templates, the server enforces a structured and machine-optimized form of interaction with the generative AI model. This reduces prompt ambiguity and leads to more consistent and statistically stable outputs across a wide variety of user requests, thereby improving overall computational efficiency because fewer retries or manual adjustments are required.

The server communicates the prompt sentence to the generative AI model. In one embodiment, the generative AI model is a transformer-based language model that includes multiple attention layers, feed-forward layers, and an output projection layer. The server encodes the prompt sentence into a sequence of token identifiers, converts each token identifier into an embedding vector, and processes the sequence through the model. The model internally computes attention weights between tokens, aggregates contextual information, and iteratively predicts output tokens using learned weight parameters. The server selects hyperparameters such as temperature, top-k, or nucleus sampling thresholds to control the variability and determinism of generation, thereby aligning the generation process with the requirement that the output be both diverse and practically resolvable to real-world items.

In another embodiment, the server hosts the generative AI model locally on one or more GPUs. The server divides the token sequence into batches, performs parallel matrix multiplications using GPU compute units, and retrieves the generated token probabilities from GPU memory. The server updates an internal output buffer with the generated tokens. Because the model weights and hidden activations are stored in GPU memory and reused across requests, the server can reduce latency and increase throughput compared to a purely CPU-based implementation.

The server receives the response text generated by the generative AI model and stores the raw response in the memory. The server then applies a post-processing algorithm to the response text. The server may use regular expressions, line delimiters, or pattern matching to separate the response into individual candidate recommendations. For each candidate, the server extracts name information and creator information, such as a title of a piece of content and the name of its author or artist. The server may also extract descriptive elements such as genre, mood, or platform suggestions if the response includes such data.

The server normalizes the extracted name and creator information by trimming extraneous characters, standardizing capitalization, and resolving simple variants (for example, removing parentheses or standardizing punctuation). The server stores the normalized candidate recommendations in a structured data format, for example a table or a list of records, each record containing at least fields for a title string, a creator string, and an optional description string. By structuring the AI-generated output, the server prepares the data for efficient comparison with external information providing systems.

The server collates the extraction result with response results from one or more external information providing systems. For each candidate recommendation, the server formulates a query that includes at least the title string and creator string. The server transmits the query via a network protocol, receives catalog records in response, and performs matching using similarity metrics. The server may compute string similarity scores using algorithms such as edit distance, token-based similarity, or cosine similarity over vectorized representations. The server may also apply rule-based filters, for instance ignoring records whose content type or release period is inconsistent with the abstract attribute information.

The server selects, for each candidate recommendation, a best-matching catalog record based on the similarity score and attribute consistency. From the selected catalog record, the server obtains identification information such as a content identifier and reference location information such as a network address (for example, a URL of a streaming resource or a product page). The server stores this information as connection information that can be used by the terminal to access the content.

The server generates recommendation result information that includes, for each candidate recommendation, the connection information and optionally additional descriptive data such as an image, a short explanation, or platform-specific availability. The server aggregates the recommendations into a structured response intended for display on the terminal, for example by grouping them into sections according to platform or domain.

The terminal receives the recommendation result information from the server, parses the data, and renders a list of recommendations on the input/output screen. The terminal may display each recommendation with a title, a creator name, a short description, and one or more buttons or links representing the connection information. When the user selects one of the links, the terminal initiates access to the reference location, which may result in opening a streaming application, a web page, or another interface where the user can acquire or use the recommended item. The terminal thus operates as a control point that triggers external content playback or acquisition based on structured connection information.

The server improves computer technology in multiple respects. By converting unstructured natural language requests into abstract attribute information and then into structured prompt sentences, the server reduces the dimensionality and noise of input to the generative AI model. This structured mediation decreases the average number of tokens required in prompts, thereby reducing computational load on the model and increasing throughput. By enforcing consistent output formats through the prompt sentence, the server simplifies downstream parsing, which reduces parsing errors and leads to more stable processing pipelines.

The server further improves data management by representing internal states (requests, attributes, candidates, and connection information) using well-defined data structures. This design allows efficient indexing in databases and efficient caching of frequent attribute combinations. As a result, the server can quickly reconstruct suitable prompt sentences or reuse partial analysis results for similar requests, thereby reducing latency and server load.

The server also improves computational accuracy and reliability of recommendation resolution. Because the generative AI model is not treated as the final recommendation layer but as a generator of candidate items, the server performs a second-level resolution against external catalog data. This two-stage process significantly reduces the probability of returning items that do not exist or that do not match availability constraints. The server combines neural-network-based semantic reasoning (for content selection) with deterministic catalog matching (for access resolution), which is a non-conventional combination that yields both flexible understanding of user intent and robust technical integration with external systems.

The server uses specific non-human rules and procedures to handle AI model interaction. For example, the server dynamically adjusts the number of recommendations requested in the prompt sentence based on detected attributes such as domain or user device type, in order to balance information density and rendering constraints on the terminal. The server may further impose strict constraints in the prompt sentence regarding output structure and content categories, thereby guiding the generative AI model toward outputs that are easier to reconcile with external systems. These measures are specifically designed for machine efficiency and catalog resolution and would not arise from mere manual human practices.

In one embodiment, the generative AI model is trained by the server or by a training system under control of the same operator. The model may be a transformer neural network trained on large text corpora including content descriptions and user reviews. The training process may involve minimizing a cross-entropy loss between predicted tokens and ground-truth tokens. The training system may use mini-batch gradient descent, backpropagation through time, and optimization algorithms such as Adam. The server may fine-tune an existing base model using domain-specific data related to subculture content, such as descriptions of works, genres, and user preference annotations, thereby adjusting the model's parameters to better handle domain-specific vocabulary and relationships.

In another embodiment, the server maintains a separate attribute classifier model trained via supervised learning. The server may train this model on labeled request data, where each request is annotated with domain labels, genre labels, and mood labels. The server may use a loss function that combines cross-entropy losses for each attribute type, and may employ regularization techniques to prevent overfitting. During inference, the server uses the classifier's output probabilities to select attribute values that maximize consistency across attributes, which contributes to more accurate abstract attribute information.

The server may employ data augmentation techniques during training, such as paraphrasing requests, adding noise, or reordering phrases, to increase model robustness. Because the abstract attribute information is derived from such robust models, the prompt sentence generation remains stable even when user input contains informal language, typographical errors, or code-switching between languages. This leads to a concrete technical effect of reduced error rate in attribute extraction and, consequently, more accurate and consistent recommendation behavior.

The server may implement alternative embodiments for different types of content. For audio content, the server may include attributes such as tempo range, instrumentation, vocal presence, and loudness characteristics. For document content, the server may include attributes such as difficulty level, reading length, and technicality. For visual content, the server may include attributes such as visual tone, pacing, or age rating. The server may select an appropriate attribute schema based on the target domain inferred from the user's request. This domain-dependent attribute schema allows the server to generate specialized prompt sentences that better guide the generative AI model, and also allows more precise matching against external catalogues that store domain-specific metadata.

The server can adopt alternative internal architectures for the generative AI model. In one variation, the server uses an encoder-decoder transformer where the encoder ingests the prompt sentence and the decoder generates recommendations conditioned on the encoder's hidden states. In another variation, the server uses a decoder-only transformer that processes the prompt as a prefix and continues generation. The server can tune model size, number of layers, and attention heads according to performance and resource constraints. The use of scalable neural architectures, in combination with the structured attribute and prompt pipeline, allows the system to maintain low latency and high throughput even with a high volume of simultaneous requests.

The server, by tightly integrating request analysis, prompt sentence construction, and downstream catalog resolution, provides a specific improvement in computer functionality. The server reduces the need for manual feature engineering and rule maintenance because the generative AI model handles semantic reasoning, while the server's structured attribute schema and two-stage matching pipeline ensure that outputs are technically actionable and consistent with external systems. The resulting reduction in manual configuration, reduction in redundant computations, and improved success rate of link resolution constitute concrete technical effects beyond mere automation of human judgment.

The user thus interacts with a system in which the server, the terminal, and the generative AI model cooperate in a specific, technically defined manner. The server performs structured data transformations, executes algorithmic processing flows, and controls communication with external devices and services to generate recommendation result information that is directly usable for accessing real-world content, rather than simply displaying abstract suggestions. This configuration and operation enable other practitioners to implement the invention on various hardware and software platforms while preserving the technical advantages described above.

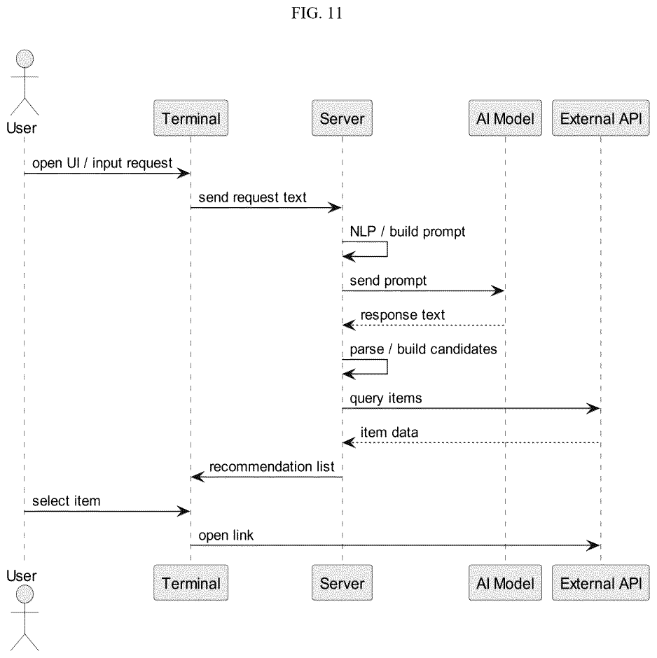

The following describes the processing flow using FIG. 11.

### Step 1

User operates the terminal to access an application provided by the server and views an input/output screen including at least one text input field. User inputs a concrete request in natural language (input: user's desired content description as character information) and confirms the input via a submit operation. As a result, the terminal holds the entered character information and associated UI state (output: request text stored in a terminal-side data structure).

### Step 2

Terminal executes client-side code to validate the entered character information. Terminal checks that the input is not empty and may trim leading and trailing whitespace (input: raw request text). Terminal then packages the validated text into a message structure including fields such as request text, optional user identifier, and timestamp (output: structured request message). Terminal transmits this structured request message to the server over a network connection using a protocol such as HTTPS.

### Step 3

Server receives the structured request message from the terminal via a communication interface (input: structured request message). Server parses the message, extracts the request text and metadata, and validates encoding and length. Server then stores the original text and metadata as a record in a storage system (output: stored request record identified by a request ID).

### Step 4

Server executes a natural language processing algorithm to analyze the request text (input: request text from the stored request record). Server tokenizes the text, converts tokens into embeddings, and applies a trained model such as a transformer-based encoder to generate contextual representations. Server then applies one or more classification layers and rule-based filters to infer abstract attribute information, including a target domain, preference attributes, and constraint conditions (output: abstract attribute data structure associated with the request ID).

### Step 5

Server constructs a prompt sentence based on the abstract attribute information (input: abstract attribute data structure). Server selects an appropriate template according to the target domain, fills placeholders (such as genre, mood, number of items, and output format) with values from the abstract attributes, and concatenates the user's original request text when required. Through string operations and template substitution, the server generates a single coherent prompt sentence tailored to the generative AI model (output: prompt sentence string stored in association with the request ID).

### Step 6

Server prepares a model invocation request for the generative AI model (input: prompt sentence string and model configuration parameters such as temperature and maximum token count). Server encapsulates the prompt in a model-specific request format and performs communication processing to send the request to the generative AI model endpoint, either locally or via a remote API. Server waits for a response and handles timeouts or errors (output: raw model response message containing response text and optional token usage information).

### Step 7

Server extracts the response text from the model response message (input: raw model response). Server verifies that the response text is not empty and stores it in the storage system together with the request ID and prompt sentence, thereby creating a record of the interaction (output: stored response text associated with the request record).

### Step 8

Server parses the response text to identify individual candidate recommendations (input: stored response text). Server applies text parsing rules, such as splitting by line breaks or bullet markers, and may use regular expressions to detect structured segments. For each detected segment, server extracts name information (e.g., title) and creator information (e.g., author or artist) by pattern matching or simple NLP heuristics. Server normalizes these textual fields through case normalization and trimming, and organizes them into a list of candidate recommendation records (output: structured list of candidate recommendations containing at least title and creator for each item).

### Step 9

Server collates each candidate recommendation with information from an external information providing apparatus (input: list of candidate recommendations). For each candidate, server constructs a query including the title and creator strings, sends the query to an external catalog API, and receives a set of catalog entries. Server computes similarity scores between candidate data and catalog data using string similarity algorithms and attribute checks. Server selects the best match for each candidate and retrieves identification information and reference location information from the matched catalog entry (output: list of resolved recommendation items with content identifiers and access locations).

### Step 10

Server generates recommendation result information from the resolved recommendation items (input: list of resolved recommendation items with identifiers and access locations). Server creates a response data structure that includes, for each item, the title, creator, optional description, and connection information (such as an access URL). Server may also include metadata such as platform name or availability region. By aggregating these records, the server forms a response payload suitable for presentation on the terminal (output: structured recommendation result payload linked to the request ID).

### Step 11

Server transmits the recommendation result payload to the terminal (input: structured recommendation result payload). Server serializes the payload into a format such as JSON, sets appropriate response headers, and sends an HTTP response back to the terminal. Server may optionally log transmission status and response size for performance monitoring (output: network response carrying recommendation data to the terminal).

### Step 12

Terminal receives the network response from the server (input: recommendation result payload). Terminal parses the payload into an internal representation and updates the user interface on the input/output screen. Terminal generates or updates visual elements such as lists, cards, or buttons for each recommendation item, displaying titles, creators, and visible links or buttons derived from connection information (output: rendered recommendation list presented on the terminal display).

### Step 13

User reviews the presented recommendation list on the terminal (input: rendered recommendation items). User selects a desired candidate by tapping or clicking on a corresponding link or button. This user action triggers a control event in the terminal's client application (output: user selection event indicating a chosen recommendation and associated connection information).

### Step 14

Terminal handles the user selection event (input: connection information associated with the selected recommendation). Terminal uses the connection information, such as a network address or deep link, to initiate access to the referenced content. Terminal either opens a new browser tab, launches an external application, or navigates within the current application to the specified reference location. As a result, the terminal establishes communication with an external content service or device and initiates acquisition or playback of the selected content (output: active connection to external service and commencement of content access).

### Step 15

Server optionally records interaction data related to the user's selection (input: notification or log message from the terminal, or server-side logs of link redirection). Server associates click or usage information with the original request ID and candidate recommendation records. Server stores this interaction data for subsequent analysis, model retraining, or refinement of attribute extraction and prompt construction rules (output: updated analytics or log records that capture actual usage patterns of recommendations).

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional recommendation systems for cultural content, such as audio works, visual works, and textual works, typically rely on fixed rule-based filtering or simple similarity calculations based on pre-defined metadata. Such systems often operate on static catalogs with limited context regarding a user's concrete request and provide only a ranked list of items without seamlessly connecting the recommendation result to actual content acquisition or viewing on external platforms. As a result, the user has to manually search across multiple content distribution platforms, manually match titles, and manually identify valid access points, which introduces latency, increases network and computational overhead on client devices, and degrades the overall user experience.

In particular, where generative AI models are available as external services, conventional systems either use the models in an ad-hoc manner—simply forwarding user text and displaying the raw output—or do not integrate the models with downstream processing stages that structure the output and link it to concrete, machine-usable identifiers on distribution platforms. Consequently, the rich semantic understanding capability of the generative AI model is not effectively utilized to drive automated data processing, such as platform searching, link generation, and structured association between recommended items and access URLs. This results in redundant queries, increased processing on user terminals, and inefficient use of network and server resources.

Moreover, existing architectures frequently require the user terminal to perform significant portions of parsing, external API access, and link construction. Such offloading to heterogeneous terminals leads to inconsistent behavior, higher error rates, increased power consumption, and complexity in client-side software. From the standpoint of computer technology, the data flow from user request, to generative AI analysis, to platform search, and finally to link generation is fragmented and not optimized as an integrated server-side pipeline.

Accordingly, there is a need for a server-side system and method that transforms unstructured user requests into structured, actionable recommendation results by (i) systematically constructing prompt sentences for a generative AI model, (ii) parsing and normalizing the model output into structured items, (iii) automatically searching multiple content distribution platforms using server-side resources, and (iv) generating association information that directly encodes platform-specific access identification information. By centralizing these operations on a server, the system can reduce client-side computation, optimize network usage, and improve overall responsiveness and reliability of the recommendation process.

The specific processing by the specific processing unit 290 of the data processing device 12 in Application Example 1 is realized by the following means.

The present invention provides a server comprising a processor configured to provide an input/output interface for receiving, from a user terminal, concrete requests in natural language regarding cultural content; a processor configured to generate, based on the received concrete requests, a prompt sentence in natural language, to construct query data including the prompt sentence, and to transmit the query data to a generative AI model executed on an information processing resource; a processor configured to receive, from the generative AI model, a recommendation result including a list of cultural content items, and to analyze the recommendation result to extract individual cultural content items as structured data; a processor configured to search, for each of the extracted cultural content items, one or more content distribution platforms on which viewing or acquisition of the cultural content items is available, by using at least one external information processing device or storage device; a processor configured to generate association information that associates each of the cultural content items with at least one of the content distribution platforms, and to append, to the association information, reference information including access identification information enabling access to the content distribution platforms; and a processor configured to transmit the association information and the reference information to the user terminal as a recommendation result displayable on the user terminal. This enables an integrated, server-centric processing pipeline in which unstructured user requests are automatically converted into structured recommendation results that are directly linked to concrete access points on multiple content distribution platforms, thereby reducing processing load on user terminals, minimizing redundant network interactions, and improving the efficiency and technical performance of the recommendation service as a whole.

The term “system” refers to an arrangement including one or more hardware components and software components that cooperate to perform processing related to receiving user requests, generating recommendations using a generative AI model, and providing recommendation results.

The term “processor” refers to one or more hardware-based processing units, such as a central processing unit, a graphics processing unit, or a dedicated accelerator, configured to execute instructions for performing the functions described in the claims.

The term “input/output interface” refers to a hardware and software mechanism that enables exchange of data between the processor and external devices, including at least a communication interface for sending and receiving data to and from a user terminal.

The term “user terminal” refers to an information processing device operated by a user, such as a mobile device, a tablet device, a personal computer, or a similar computing device capable of transmitting requests and displaying recommendation results.

The term “concrete request” refers to a user-provided input expressed in natural language that specifies one or more conditions or preferences regarding cultural content to be recommended.

The term “natural language” refers to a human language, such as a spoken or written language, that is understandable by humans and is not limited to a formal programming or query language.

The term “prompt sentence” refers to a text sequence in natural language generated based on a concrete request, the text sequence being intended to be supplied as input to a generative AI model to elicit a recommendation result.

The term “query data” refers to structured data, including at least a prompt sentence, formatted according to an interface specification of a generative AI model and transmitted from the processor to the generative AI model.

The term “generative AI model” refers to a machine learning model that processes a prompt sentence and generates output content, including at least a list of recommended items, based on learned statistical relationships in training data.

The term “information processing resource” refers to a computing infrastructure, such as a server, a virtual machine, or a cloud computing environment, configured to execute the generative AI model and process query data.

The term “recommendation result” refers to output data generated by the generative AI model in response to a prompt sentence, the output data including at least a list of recommended cultural content items.

The term “cultural content item” refers to a work or piece of content intended for human consumption and appreciation, including but not limited to audiovisual works, audio works, textual works, interactive works, and similar creative products.

The term “structured data” refers to data that is organized into defined fields or elements, such as records, lists, or objects, in a format that allows programmatic access to individual cultural content items and related attributes.

The term “content distribution platform” refers to a computerized service that provides viewing, streaming, downloading, rental, purchase, or other forms of access to cultural content items.

The term “external information processing device” refers to a computing device or service distinct from the processor of the system, such as an external server or external service, that can be accessed via a communication network to obtain information about cultural content items.

The term “storage device” refers to a hardware component or service for storing data, including but not limited to a database system, a file storage system, or a cloud-based storage service.

The term “association information” refers to data that specifies a relationship between a cultural content item and at least one content distribution platform on which the cultural content item is available.

The term “reference information” refers to data appended to the association information and including at least one access identification information element that can be used to access a content distribution platform.

The term “access identification information” refers to information such as a uniform resource locator, a resource identifier, or other platform-specific identifier that uniquely specifies a location or resource on a content distribution platform.

The term “displayable” refers to being presented or capable of being presented in a human-perceivable form, such as text, icons, or graphical elements, on a display unit of a user terminal.

In one embodiment, a server provides a recommendation system that utilizes a generative AI model to convert free-form user requests regarding cultural content into structured recommendation results that are directly linked to access information of content distribution platforms. The server cooperates with a terminal operated by a user over a communication network.

The server includes at least one processor, a main memory, a non-volatile storage device, and a network interface. The processor may be a general-purpose central processing unit or a combination of a central processing unit and an accelerator such as a graphics processing unit. The server executes an operating system, for example a UNIX-compatible operating system, and application software including a web server component and an application programming interface component. The server stores program modules for request handling, prompt sentence generation, generative AI interaction, recommendation result parsing, platform search, association information generation, and response transmission.

The terminal includes a processor, a memory, a display, input devices such as a touchscreen, and a wireless or wired communication interface. The terminal executes an operating system for mobile or desktop environments and an application that communicates with the server. The terminal displays a user interface allowing a user to input a concrete request in natural language, such as “I want to watch an anime with strong fantasy elements.” The terminal transmits the input text to the server via a secure network protocol and receives a structured recommendation result for display.

The server generates and executes a program that implements specific data structures and algorithms to support the claimed system. The server stores user requests in a request record structure that includes fields such as a user identifier, a request text field, a timestamp, and a processing status flag. The server stores recommendation results in a recommendation record structure that includes a list of content item objects. Each content item object has fields such as a normalized title, a content type, a list of associated platform objects, and internal identifiers. Each platform object includes a platform identifier, a content-specific resource identifier, a content distribution type (for example, streaming, rental, or purchase), and access identification information such as a uniform resource locator.

The server uses software modules to transform and analyze data. A prompt generation module receives the request text and constructs a prompt sentence in natural language by applying a template-based algorithm. For example, the server generates a prompt sentence such as:

“You are a recommendation assistant. Based on the following request, recommend several cultural contents (anime titles). Output the titles as a list. Request: I want to watch an anime with strong fantasy elements.”

In another example related to audio content, the server generates a prompt sentence such as:

“Please recommend five anime series with strong fantasy elements suitable for a young adult audience. Output only a numbered list of titles, without explanations.”

In still another example related to audio content, the server generates a prompt sentence such as:

“Please recommend ten J-pop songs with an upbeat tempo that are suitable for a workout playlist. Output only a numbered list of song titles and artist names.”

The server does not simply forward the user text to the generative AI model, but applies rule-based and statistical transformations to normalize the text, remove unsupported characters, and add explicit constraints on output format. This improves downstream parsing accuracy and reduces computational overhead in the parsing module.

The server utilizes a generative AI model that is implemented as a multi-layer neural network. In one embodiment, the generative AI model is a transformer-based architecture comprising an encoder-decoder or decoder-only stack of self-attention layers, feed-forward layers, and normalization layers. The generative AI model internally represents tokens, including subword units, by embedding them into high-dimensional vectors. The generative AI model performs self-attention operations over sequences of tokens to compute contextualized representations using weighted sums of value vectors, where the weights are computed from similarity scores between query and key vectors. The model applies learned weight matrices and non-linear activation functions in each layer to produce output token probability distributions. The generative AI model has been trained with a large-scale corpus of text and has learned parameters such as attention weight matrices, feed-forward layer weights, and layer normalization parameters by minimizing a loss function, for example a cross-entropy loss, using stochastic gradient descent or a variant thereof.

The server uses a model interface module to format the prompt sentence into a data structure suitable for the generative AI model. This module converts the prompt sentence into a sequence of tokens according to a tokenization scheme used by the generative AI model, constructs an input array of token identifiers, and sets configuration parameters, including a maximum output token length, a sampling temperature, and a top-k or top-p sampling threshold. The server transmits this formatted input to an information processing resource executing the generative AI model. The generative AI model computes, layer by layer, attention scores, contextualized vectors, and output token distributions, and generates a sequence of output tokens that represent a list of cultural content items. The server receives the output sequence and decodes the tokens back into a character string using the same tokenization scheme.

The server then applies a parsing module designed specifically to convert the generative AI model output into structured data. This parsing module does not rely merely on generic text parsing; instead, it uses a deterministic algorithm that scans for enumerated list markers, such as numerical prefixes or bullet symbols, and applies normalization rules to each line. The server maps each detected line into a content item object and stores it in memory. The server optionally applies string normalization algorithms, such as case folding, removal of diacritics, full-width to half-width character conversion, and mapping to canonical forms stored in a metadata table.

The server performs a platform search using an external access module that is configured to query multiple content distribution platforms and internal storage. This module uses specific search strategies tailored to the normalized titles, such as exact match search, approximate string match using edit distance or token-based similarity, and language-specific normalization. The server structures each request to an external information processing device or storage device using well-defined application programming interfaces and processes the responses to extract platform-specific content identifiers. By centralizing this search logic in the server, the system prevents each terminal from issuing independent search queries to multiple platforms, thereby reducing aggregate network traffic and avoiding redundant computations across terminals.

The server generates association information by combining normalized titles with the obtained platform identifiers. The server constructs reference information including access identification information by applying platform-specific URL construction templates or by using identifiers directly returned by platform APIs. The server organizes this association information as structured data ready for direct consumption by the terminal user interface. Because the association information encodes both semantic recommendation output and technical access paths, the terminal can present actionable controls, such as “Watch on Platform X” or “Buy on Platform Y,” without performing its own platform search or link construction.

The server thereby improves computer technology in several ways. First, by performing structured prompt generation and constrained output formatting, the server reduces the entropy and variability of the generative AI model's output. This reduction in variability enables the parsing module to operate with bounded computational complexity and lower error rates, which translates to faster processing and fewer retries or error-handling routines. Second, by centralizing platform search and association formation at the server, the system reduces the number of network round trips and external API calls required per user request, improving overall throughput and reducing latency. Third, by using normalized canonical titles and structured association records, the server achieves more accurate matching between generative AI model output and actual catalog items, thereby reducing mismatches and failed link resolutions.

The server further optimizes data management by storing intermediate results in indexed data structures and caching frequently requested content associations. For example, the server can maintain a cache mapping normalized titles to known platform identifiers. When a subsequent generative AI output includes a previously seen title, the server can retrieve association information from the cache instead of repeating external platform queries. This improves response time and reduces load on external information processing devices and storage devices.

The server uses algorithms that are not equivalent to manual human work. In contrast to a human operator reading a recommendation list and manually searching for content on various platforms, the server applies machine-parsable templates, fixed output patterns, tokenization schemes, vector operations, and neural network inference to process requests in a high-dimensional feature space. The generative AI model determines relevance of content items based on statistical relationships among tokens learned from large-scale corpora, using attention mechanisms and learned embeddings that have no direct human analog. The platform search module uses deterministic algorithms with explicit similarity thresholds and pre-defined fallback rules that systematically handle ambiguous or partially matching titles, which is beyond typical manual search procedures.

The server can implement alternative embodiments of the generative AI model and related modules. In one embodiment, the generative AI model is a decoder-only transformer trained with masked language modeling. In another embodiment, the generative AI model uses encoder-decoder architecture with separate attention modules for encoding the prompt sentence and decoding the output. In yet another embodiment, the server uses a fine-tuned variant of the model adapted for cultural content recommendation by additional training on curated recommendation datasets. The server may adjust hyperparameters, such as number of layers, hidden dimension size, number of attention heads, and learning rate schedules, to optimize inference accuracy and computational efficiency.

The server may also implement different strategies for generating prompt sentences depending on the category of content. For music-related requests, the server may embed additional constraints such as tempo, mood, or language. For textual content, the server may incorporate explicit references to themes or user concerns. For example, the server may generate a prompt sentence such as:

“Please recommend several books that can help with stress management for working adults. Output only a numbered list of book titles.”

By encoding such category-specific constraints in the prompt sentence, the server guides the generative AI model to produce structured, domain-relevant recommendations that are easier to map onto actual catalog entries.

The terminal benefits from the server's processing in that the terminal only needs to transmit the user's concrete request and display the resulting structured recommendation data. The terminal does not perform generative AI inference, extensive text parsing, or multi-platform content search. This reduces the computational load, power consumption, and memory requirements on the terminal, which is especially advantageous for resource-constrained mobile devices. The reduced processing on the terminal also leads to more predictable and uniform behavior across different types of terminals.

The user interacts with the system by entering requests in natural language, examining the recommended content items presented by the terminal, and selecting a desired platform link. The user thereby experiences a seamless flow from expressing an abstract preference, such as “I want to watch an anime with strong fantasy elements,” to accessing a specific content distribution platform page for a recommended work. The server's technical processing enables this flow by transforming unstructured language into structured, platform-resolvable information.

In alternative embodiments, the server may incorporate additional modules to adjust ranking of recommended items based on historical user behavior stored in a secure manner. The server can, for example, store anonymized preference vectors derived from past user interactions and incorporate these vectors as additional features in determining how to order association information. Such ranking algorithms may involve calculating similarity scores between user preference vectors and latent vectors associated with recommended items, thereby refining the ordering without altering the underlying generative AI model.

In another embodiment, the server may use ensemble methods combining outputs from multiple generative AI models or combining generative AI outputs with rule-based filters. For instance, the server may apply a second-stage filter that removes items not available in a particular geographic region or not compatible with a user's device capabilities, based on platform metadata. Such processing further connects the generative AI result to concrete technical constraints of distribution platforms and devices, thereby enhancing technical suitability and reliability of the system.

By integrating all of these modules—prompt generation, transformer-based neural inference, constrained parsing, platform search, association construction, caching, and terminal-oriented response formatting—within a single server-controlled pipeline, the system goes beyond automating a human workflow. The system implements a specialized computer architecture and data processing flow that improves processing speed, recommendation precision, network efficiency, and robustness of content access, thus providing a concrete technological improvement in recommendation systems that employ a generative AI model and a prompt sentence-based interaction.

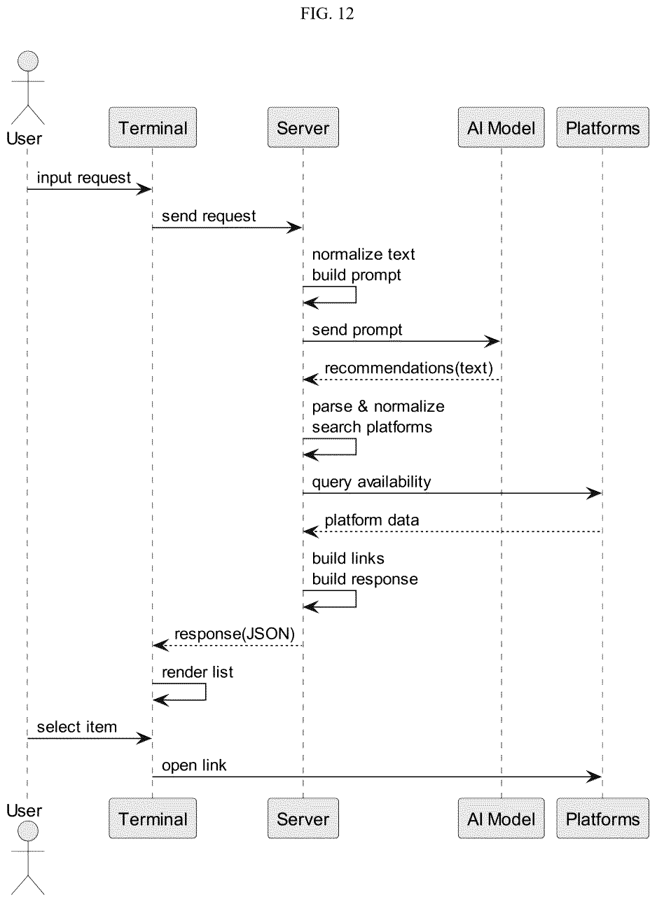

The following describes the processing flow using FIG. 12.

### Step 1

User uses the terminal to launch an application for cultural content recommendation and inputs a concrete request in natural language.

User provides the input via a touchscreen keyboard, voice-to-text interface, or other input means, for example entering the text “I want to watch an anime with strong fantasy elements.”

Terminal receives the raw input events, converts them into a UTF-8 encoded text string, and stores the text string in a request object in memory as an input.

Terminal generates a JSON payload including fields such as a user identifier, the request text, and a timestamp, and transmits this payload as an HTTPS request to the server.

The input of this step is user interaction on the terminal; the output of this step is a structured network request containing the natural-language request text sent from the terminal to the server.

### Step 2

Server receives the HTTPS request via a network interface and a web server component.

Server parses the HTTP headers and the JSON body to extract the user identifier, request text, and timestamp as input data.

Server performs validation by checking authentication tokens, input length limits, and content type, and discards or flags invalid requests.

Server logs the validated request into a request log table in storage, associating a unique request identifier with the user identifier and the raw text.

The input of this step is the JSON payload from the terminal; the output of this step is a validated and logged request record stored on the server, ready for further processing.

### Step 3

Server uses the request text as input to a text preprocessing module.

Server normalizes the text by converting character encodings, standardizing whitespace, converting full-width characters to half-width characters where applicable, and performing case normalization.

Server may apply language detection and remove unsupported control characters to create a cleaned text string.

Server stores the cleaned text string in a normalized-text field of the request record.

The input of this step is the raw request text; the output of this step is a normalized request text that is suitable for prompt generation.

### Step 4

Server generates a prompt sentence using the normalized request text as input.

Server selects a prompt template based on a content category inferred from the text, for example anime, music, or books, and fills template placeholders with the normalized request text.

Server constructs a prompt sentence such as “You are a recommendation assistant. Based on the following request, recommend several cultural contents (anime titles). Output the titles as a list. Request: I want to watch an anime with strong fantasy elements.”

Server writes the prompt sentence into a prompt field associated with the request record.

The input of this step is the normalized request text and a selected template; the output of this step is a fully formed prompt sentence in natural language.

### Step 5

Server prepares query data for a generative AI model using the prompt sentence as input.

Server tokenizes the prompt sentence into a sequence of tokens according to the tokenization scheme used by the generative AI model, for example subword units.

Server constructs a data structure containing token identifiers, attention masks, and configuration parameters such as maximum output length, temperature, and sampling thresholds.

Server encapsulates this data structure into a request message compatible with an API or internal interface of the generative AI model.

The input of this step is the prompt sentence; the output of this step is formatted query data that can be processed by the generative AI model.

### Step 6

Server transmits the formatted query data to an information processing resource executing the generative AI model.

Server uses a network protocol or an inter-process communication mechanism to send the query, including model parameters and the tokenized prompt, as input to the generative AI model.

Generative AI model processes the input by performing multi-layer neural network computations: the model converts token identifiers into embeddings, applies self-attention and feed-forward transformations, and generates output token probability distributions step by step.

Server receives the output token sequence from the generative AI model and decodes the tokens back into a text representation of the recommendation result.

The input of this step is the tokenized query data; the output of this step is a raw text response containing a list of recommended cultural content items.

### Step 7

Server parses the raw text response from the generative AI model to extract individual recommended items.

Server uses a parsing algorithm that scans for line breaks, list markers such as “1.” or “-”, and other separators, and splits the response into candidate lines.

Server trims whitespace, removes leading numbering or bullet symbols, and excludes empty lines to obtain clean title strings.

Server constructs a list of content item objects, each containing at least a title field, and stores this list as structured data in memory.

The input of this step is the raw recommendation text; the output of this step is a structured list of recommended cultural content items.

### Step 8

Server normalizes the extracted content item titles for more reliable platform search.

Server applies string normalization techniques such as case folding, accent removal, and mapping of variants to canonical title forms stored in a metadata table.

Server computes hash keys or index keys for each normalized title and stores these keys in association with the content item objects.

Server updates the content item list so that each item includes both the original title and the normalized title.

The input of this step is the list of unnormalized titles; the output of this step is a list of normalized content item objects prepared for platform lookup.

### Step 9

Server performs platform search using the normalized titles as input.

Server issues search queries to external content distribution platforms and internal catalogs, constructing search URLs or API requests using the normalized titles and optional additional metadata.

Server receives responses from the external information processing devices or storage devices, parses the responses, and extracts platform identifiers, content identifiers, availability information, and geographic or device restrictions.

Server integrates these results into a mapping between each normalized title and one or more platform entries.

The input of this step is the normalized content item list; the output of this step is a platform mapping that associates each content item with specific platform-level content identifiers and availability attributes.

### Step 10

Server generates association information using the platform mapping as input.

Server creates association records for each content item, each record containing the content identifier, platform identifier, platform type, and any additional metadata such as subscription requirement or content format.

Server generates reference information by constructing access identification information such as URLs or deep links, using platform-specific URL templates and the retrieved content identifiers.

Server appends the reference information to each association record and builds a complete association data structure for all recommended items.

The input of this step is the platform mapping; the output of this step is a structured set of association and reference information linking each recommended item to concrete access paths.

### Step 11

Server formats a response message using the association and reference information as input.

Server creates a response object that includes a list of recommended content items, each with human-readable titles and corresponding platform entries including display names and access URLs.

Server serializes this response object into a data format suitable for transmission, such as JSON, and adds status information and optional error messages if any items could not be resolved.

Server transmits the serialized response to the terminal via an HTTPS response.

The input of this step is the association and reference data structure; the output of this step is a formatted response message sent from the server to the terminal.

### Step 12

Terminal receives the response message from the server and uses it as input to its presentation module.

Terminal deserializes the received data, reconstructing objects or data structures representing recommended content items and associated platform links.

Terminal generates user interface elements, such as list entries and buttons labeled with platform names, and binds each button to the corresponding access URL.

Terminal renders the list of recommended items on the display so that the user can view the titles and available platforms.

The input of this step is the JSON response from the server; the output of this step is a visual representation of the recommendation result on the terminal display.

### Step 13

User views the displayed recommendations on the terminal and selects a desired cultural content item and platform.

User taps or clicks on a button corresponding to a particular platform entry, generating an input event that the terminal application captures.

Terminal retrieves the associated access URL or deep link from its in-memory data structure based on the selected item and platform.

Terminal invokes an operating system function to open the URL, which launches a web browser or a native platform application and navigates to the content's viewing or purchase page.

The input of this step is the user's selection event and the stored access URLs; the output of this step is opening of the appropriate content distribution platform interface, enabling the user to access the recommended cultural content.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional recommendation systems that rely on fixed rules or simple keyword matching suffer from several technical limitations when processing free-form natural language inputs from users. First, when a user provides an unstructured description of a concern or request, conventional systems often perform only shallow text matching, which fails to robustly extract semantically meaningful keywords or intents. As a result, the search queries derived from such inputs are noisy or incomplete, and the underlying information retrieval mechanisms produce low-relevance or inconsistent results, thereby degrading system performance and user experience.

Second, many existing architectures do not structurally integrate a generative AI model into the end-to-end processing pipeline in a way that leverages the model both for semantic analysis and for controlled generation of search-oriented metadata. Instead, generative models, if used at all, are typically invoked in an ad hoc manner, without a standardized prompt construction process, without validation or logging of intermediate representations, and without feedback between the AI-derived keywords and the search subsystem. This leads to brittle behavior, difficulty in debugging and optimizing system performance, and inefficient use of computational resources.

Third, traditional systems lack a well-defined mechanism for transforming the raw output of a natural language model into structured search conditions that can be reliably consumed by an information storage device or a search processing mechanism. In particular, there is often no explicit step of normalizing the user's prompt sentence, storing it with log-management information, generating structured keyword data, and then programmatically constructing and executing search conditions over heterogeneous information items such as document data, product data, and service data. This absence of a standardized processing chain results in poor controllability of the recommendation behavior and reduces the system's ability to scale to large and diverse information collections.

Fourth, even when relevant items are retrieved, conventional systems frequently provide only raw search results (e.g., titles and links) without any machine-generated summaries, explanations of relevance, or structured output formatting. This makes it more difficult for users to understand why particular items are recommended, and it limits the ability of client terminals to present results in a consistent, interactive manner. From a computing perspective, this represents an under-utilization of the generative capabilities of modern AI models, and it fails to optimize the human-computer interface for decision making and navigation.

Accordingly, there is a need for a computer-implemented technique that improves the technical process of handling natural language requests, by (i) normalizing and logging user prompt sentences, (ii) constructing explicit prompt sentences for a generative AI model, (iii) using the model to obtain structured keyword information and explanatory text, (iv) converting that information into machine-executable search conditions against an information storage device, and (v) formatting and delivering recommendation information with summaries and reasons in a structured output data format to a terminal. By organizing these operations into a coherent processing pipeline controlled by a processor, the invention aims to improve the precision, robustness, and explainability of recommendation behavior, and to enhance the efficiency and reliability of the underlying computer system.

The specific processing by the specific processing unit 290 of the data processing device 12 in Example 2 is realized by the following means.

The present invention provides a server comprising a processor and a memory storing instructions that, when executed by the processor, cause the processor to provide, on a terminal, an information input and output interface for receiving a concrete request expressed in natural language from a user and to acquire, via a communication line from the terminal, a prompt sentence including the request; normalize the acquired prompt sentence as analysis target data, store the normalized prompt sentence in a storage device in association with log-management information, and construct a message for converting the prompt sentence into an input format for a generative information processing model; transmit the message to an internal or external generative information processing model, cause the generative information processing model to execute natural language processing, and acquire analysis result data including keyword information related to the request; extract the keyword information from the acquired analysis result data, generate search conditions for a plurality of information items stored in an information storage device on the basis of the keyword information, and cause the information storage device or a search processing mechanism to execute a search process in accordance with the search conditions to acquire related information candidates; perform relevance evaluation computation and filtering processing on the acquired related information candidates, select recommendation information that matches contents of the request of the user, and format the recommendation information as an output data structure including a summary description, a recommendation reason, and reference identification information; and transmit the formatted output data structure to the terminal and cause the terminal to present the recommendation information such that the recommendation information is displayable or operable on the terminal. This enables a technically improved end-to-end recommendation process in which natural language user inputs are systematically normalized, semantically analyzed by a generative AI model, converted into structured search conditions for heterogeneous information items, and returned as machine-readable recommendation information with explanations, thereby enhancing the precision, robustness, and usability of the computer-implemented recommendation system.

The term “processor” refers to one or more hardware processing units, such as a central processing unit or other computation circuitry, configured to execute instructions to perform the functions described herein.

The term “memory” refers to one or more non-transitory computer-readable storage media that store instructions and data for access by the processor.

The term “terminal” refers to an information processing apparatus, such as a portable device, a stationary device, or a display device, that communicates with the server and provides an interface for user input and output.

The term “information input and output interface” refers to a hardware and software combination on the terminal that enables a user to input data and receive output, such as a graphical user interface, touch interface, or equivalent interaction mechanism.

The term “user” refers to an entity, including an individual or an organization, that provides a natural language request through the terminal and receives recommendation information.

The term “natural language” refers to a human language that can be understood and produced by people, including spoken and written forms, and that is processed by the system without requiring a predefined formal syntax.

The term “request” refers to content expressed by the user in natural language that describes a need, concern, preference, or query for which the system is expected to provide related recommendation information.

The term “prompt sentence” refers to a data structure including one or more natural language expressions that represent the user's request and that is supplied as input, directly or indirectly, to a generative information processing model.

The term “communication line” refers to a wired or wireless communication network, including local and wide-area networks, that enables data transmission between the terminal and the server.

The term “analysis target data” refers to data derived from the prompt sentence, after normalization, that is processed by the generative information processing model or other analysis components.

The term “normalization” refers to processing operations applied to the prompt sentence, such as character encoding conversion, whitespace trimming, case unification, and format unification, so as to convert the prompt sentence into a standardized internal representation.

The term “log-management information” refers to data associated with the prompt sentence, such as timestamps, identifiers, or anonymized user information, which enable recording, tracking, and managing the processing history.

The term “storage device” refers to a hardware device for storing data, such as a hard disk drive, a solid-state drive, or a non-volatile memory device, operable to store normalized prompt sentences, log-management information, and other data.

The term “message” refers to a data structure, including fields and content, that is generated from the prompt sentence and formatted in accordance with an input specification of a generative information processing model.

The term “generative information processing model” refers to a computerized model, such as a generative AI model implementing natural language processing, configured to accept a prompt and output generated or transformed information, including analysis results and textual content.

The term “internal generative information processing model” refers to a generative information processing model that is executed within a computing environment controlled by the system operator.

The term “external generative information processing model” refers to a generative information processing model provided by a remote or third-party computing environment that is accessed via a communication interface.

The term “natural language processing” refers to computational techniques for analyzing and generating natural language text, including tokenization, semantic analysis, keyword extraction, and text generation.

The term “analysis result data” refers to data output from the generative information processing model in response to a message derived from the prompt sentence, and includes, for example, keyword information or other structured representations of the user's request.

The term “keyword information” refers to one or more words, phrases, or identifiers extracted from the analysis result data that represent significant concepts, topics, or attributes related to the user's request.

The term “information storage device” refers to a logical or physical arrangement of one or more storage devices or databases configured to store a plurality of information items for search and retrieval.

The term “information item” refers to a stored record representing data such as a document, a product, a service, or any associated metadata used as a candidate for recommendation.

The term “search condition” refers to a set of parameters, constraints, or expressions constructed from the keyword information and used to query the information storage device or a search processing mechanism.

The term “search processing mechanism” refers to logic or a subsystem, including a search engine or database engine, configured to execute a search process according to search conditions and to return related information candidates.

The term “related information candidate” refers to an information item retrieved from the information storage device by the search processing mechanism that is determined to be potentially relevant to the user's request.

The term “relevance evaluation computation” refers to processing operations that assign scores or metrics to related information candidates based on their correspondence to the keyword information or other criteria derived from the user's request.

The term “filtering processing” refers to operations that eliminate or deprioritize related information candidates according to relevance scores, thresholds, or other selection criteria.

The term “recommendation information” refers to one or more information items selected from the related information candidates as suitable responses to the user's request based on relevance evaluation and filtering.

The term “output data structure” refers to a structured representation, such as a data object or record set, that encapsulates the recommendation information together with associated metadata including a summary description, a recommendation reason, and reference identification information.

The term “summary description” refers to a condensed natural language explanation generated or selected for an information item, which outlines its essential content or characteristics.

The term “recommendation reason” refers to a natural language explanation indicating why a particular information item has been selected as recommendation information in view of the user's request.

The term “reference identification information” refers to data such as identifiers, links, or addresses that enable retrieval, display, or access to an information item associated with the recommendation information.

The term “attribute information of search target items” refers to data describing characteristics of information items, such as category, type, topic, or other metadata, which can be supplied to the generative information processing model as part of an additional prompt sentence.

The term “additional prompt sentence” refers to a prompt sentence that supplements the original prompt sentence with further information, such as attribute information of search target items, and that is used to cause the generative information processing model to generate summary descriptions or recommendation reasons.

The term “document information” refers to information items whose primary content is textual or multimedia documents, such as articles, reports, or publications, that can be recommended as solutions or references.

The term “product information” refers to information items describing tangible or intangible goods, including specifications, descriptions, and commercial details, that may be recommended for purchase or use.

The term “service information” refers to information items describing services, such as consulting, counseling, or subscription services, that may be recommended to address the user's request.

The term “concern” refers to a state, problem, or issue expressed by the user in the prompt sentence, for which the user seeks information, solutions, or guidance.

The term “solution candidate” refers to a piece of recommendation information that is selected as a potential response or aid to address the concern expressed by the user.

In one embodiment, a server cooperates with a terminal and a user to implement a recommendation system that analyzes a natural language request and returns structured recommendation information. The server includes a processor, a memory, at least one storage device, and a communication interface. The terminal includes a processor, a memory, a display, and an input device such as a touch panel or keyboard. The user operates the terminal to input a natural language request, and the terminal exchanges data with the server over a wired or wireless communication network.

The terminal executes an application, such as a web browser implemented using HyperText Markup Language and JavaScript or a native mobile application developed with a platform-specific framework. The terminal displays an information input and output interface that includes a text input field and a submit control. The terminal prompts the user with a prompt sentence, for example:

“Please enter the concern or request you currently have.

Example: I am struggling with human relationships at work and feel stressed every day.”

The user inputs a free-form text representing a request and activates the submit control. The terminal then constructs an internal data structure, such as an object in memory, containing the prompt sentence as a string together with local metadata, and transmits this information as an application-layer message to the server via a communication protocol such as Hypertext Transfer Protocol over Transport Layer Security.

The server receives the message through the communication interface and stores the raw prompt sentence and associated metadata in the memory. The server then performs normalization processing. The server applies character encoding unification to a standard encoding such as UTF-8, trims leading and trailing whitespace, unifies line breaks, and performs language-specific normalization such as converting full-width characters to half-width characters. The server also executes tokenization routines tailored to the language of the input, such as word segmentation for alphabetic languages and morphological analysis for logographic languages. The server writes both the original and normalized forms to a storage device, such as a relational database, along with log-management information including timestamps, anonymized user identifiers, and request identifiers. This logging structure allows the server to later reproduce processing, perform performance diagnostics, and improve system operation.

The server then constructs a message suitable as an input to a generative AI model. The server stores in memory a template specifying a system-level instruction and a user-level content. For example, the server constructs the following text as a prompt sentence for the generative AI model:

“You are an assistant that analyzes user concerns and extracts key topics for database search.

User's concern: I am struggling with human relationships at work and feel stressed every day.
1. Extract 3-7 important keywords about the user's concern.
2. Output only a JSON array of strings.”

The server replaces the example concern portion with the actual normalized prompt sentence supplied by the user. The server further adds constraints in the template, such as maximum keyword length, language restrictions, or output ordering, to ensure that the generative AI model produces data that can be deterministically parsed by the server.

In one embodiment, the server employs a generative AI model implemented as a multi-layer neural network, such as a transformer architecture. The generative AI model includes an embedding layer that maps each token to a dense vector, a plurality of self-attention layers that compute context-dependent representations by applying scaled dot-product attention to sequences of token vectors, and a feed-forward network that transforms these representations. The generative AI model is trained in advance on large-scale corpora of text. The server configures the generative AI model with hyperparameters such as the number of layers, the number of attention heads, the dimensionality of the embeddings, and the maximum sequence length. The server may deploy the generative AI model inside the same data center as the server, or access a generative AI model hosted in a remote computing environment via an application programming interface.

During training of the generative AI model, a training system minimizes a loss function, such as a cross-entropy loss between predicted tokens and ground-truth tokens, using an optimization algorithm such as stochastic gradient descent with momentum or an adaptive gradient method. The training system updates network weights by backpropagation of gradients computed through the layers of the model. The training system may perform regularization, data augmentation, and early stopping to improve generalization. For example, the training system can incorporate task-specific fine-tuning data that pairs user concerns with ideal keyword sets and explanation texts, and apply supervised fine-tuning with a loss function that penalizes missing keywords and extraneous tokens.

In operation, the server formats the constructed prompt sentence into an internal representation required by the generative AI model. For example, the server converts the input text into token identifiers using a vocabulary and segmentation scheme, and supplies the resulting sequence to the model together with control parameters such as temperature, top-k sampling threshold, or maximum output length. The server supplies these values via an internal function call or over a network interface, depending on whether the generative AI model is deployed locally or remotely.

The generative AI model processes the tokens by performing matrix multiplications, attention score calculations, and non-linear transformations according to its architecture. The model outputs a sequence of tokens that the server decodes into a text string. The server then parses the text string to obtain a structured representation, such as a list of keywords. The server may apply a validation procedure that checks whether the output conforms to a predefined syntactic pattern. If the output is malformed, the server may perform corrective parsing based on heuristics, or reconstruct a refined prompt sentence that instructs the generative AI model to adhere strictly to the expected output format and then re-issues the request, thereby reducing error rates and improving robustness.

The server transforms the extracted keywords into search conditions. The server stores in the information storage device a collection of information items, such as document information, product information, and service information. Each information item includes fields such as title, description, category, tags, and numerical attributes. The server pre-processes these information items offline by computing additional feature representations. For instance, the server generates vector embeddings of titles and descriptions using a separate embedding model, and stores these vectors in a vector index to support similarity search.

When forming search conditions, the server associatively weights the keywords according to their importance. The server may measure importance using criteria such as frequency within the user prompt sentence, position in the text, or semantic specificity estimated from language model statistics. The server then constructs a structured query that includes a combination of keyword-based filters and vector similarity thresholds. For example, the server may require that at least one high-importance keyword appears in the title or tags of an information item, while using vector similarity scoring to rank items based on semantic closeness between the keyword embedding and the item embedding.

The server submits the search conditions to a search processing mechanism, which can be integrated into the information storage device or implemented as a separate search engine. The search processing mechanism computes relevance scores using a combination of lexical relevance (such as term frequency-inverse document frequency) and vector similarity metrics (such as cosine similarity). The search processing mechanism returns a ranked list of related information candidates. By using precomputed embeddings and index structures, the server reduces search latency and improves scalability when operating on large datasets.

The server then performs relevance evaluation computation and filtering. The server combines the scores from the search processing mechanism with additional metrics, such as historical click-through rates or user preference profiles, and computes a composite relevance score for each candidate. The server removes candidates whose scores fall below a threshold or that conflict with explicit exclusion criteria, such as prohibited categories. The server may apply a diversity-promoting algorithm that penalizes items that are too similar to one another to ensure that the final set of recommendation information covers multiple aspects relevant to the user's concern.

To enhance explainability and user comprehension, the server formats the recommendation information into an output data structure that contains a summary description, a recommendation reason, and reference identification information such as a link or identifier. The server may generate the summary description and recommendation reason by constructing another prompt sentence for the generative AI model. For example, the server constructs a prompt sentence such as:

“You are an assistant that generates concise recommendations.

User's concern: I am struggling with human relationships at work and feel stressed every day.

Item: Title: Improving Communication at Work, Description: A practical guide to better workplace communication and collaboration.

Generate:
1. A short summary in 2-3 sentences.
2. A one-sentence explanation of why this item is suitable for the user's concern.”

The server replaces the example concern and item description with actual data. The server sends this prompt sentence to the generative AI model and receives generated text for the summary and explanation. The server may apply a rule-based post-processing step that enforces length limits, removes disallowed phrases, or harmonizes terminology. Because the generative AI model uses internal semantic representations of both the user concern and the information item, the generated explanation can highlight specific textual or conceptual overlaps that a purely rule-based system would not capture, thereby providing more precise and contextually relevant justifications.

The server constructs the final output data structure as an internal object or record containing, for each piece of recommendation information, fields for the title, summary description, recommendation reason, and reference identification information. The server serializes this structure into a response format suitable for the terminal and transmits it through the communication interface. The terminal receives the response, deserializes the structure, and renders the recommendation information on the display using a graphical user interface framework. The terminal may present clickable titles, short text summaries, and action controls that open a detailed page or initiate an external action such as accessing a content server or an electronic commerce platform.

This configuration and data flow produce several technical effects beyond mere automation of human mental tasks. The server reduces the amount of raw natural language data that must be transmitted between the terminal and the server by normalizing and compacting user inputs into structured representations and by using the generative AI model to extract only salient keyword information. The server thereby lowers communication overhead, particularly in environments with constrained bandwidth or high latency. The server further improves processing speed by employing precomputed embeddings, indexed storage, and optimized search conditions tuned by the generative AI model outputs, enabling faster retrieval of relevant items over large datasets.

In addition, the server increases recommendation accuracy and reduces error rates by combining neural network-based semantic understanding with deterministic post-processing rules. The generative AI model maps complex user concerns to an intermediate keyword representation that captures latent semantics, and the server then uses this representation to form queries that are better aligned with the structure of the information storage device. This layered architecture improves precision in identifying relevant documents, products, or services compared with conventional systems relying solely on surface keyword matching.

The server also enhances data management by associating each prompt sentence and its derived keywords, search conditions, and recommendation results with log-management information. The server can use this linkage to detect systematic errors, update prompt templates, retrain the generative AI model, or adjust weighting functions in the search algorithm. By treating intermediate data structures as first-class entities in the processing pipeline, the server enables fine-grained monitoring and optimization of system behavior, which constitutes an improvement in computer system operation.

The described architecture differs from human reasoning and from simple rule-based automation. The generative AI model employs high-dimensional vector operations, attention mechanisms, and trained parameters to represent context and meaning, and the server enforces non-conventional processing rules such as strict format validation of model outputs, structured keyword weighting, and combined lexical-vector retrieval. These mechanisms are not natural mental processes and are specifically designed to utilize the hardware capabilities of the processor, memory, and storage devices. As a result, the system achieves lower response latency, higher throughput, and better scalability than manual or naive computer implementations of recommendation tasks.

Alternative embodiments are also possible. The server may host the generative AI model locally in a specialized processing unit such as a graphics processing unit or a tensor processing unit, thereby reducing round-trip latency and enabling tighter integration between the model and the search module. The server may also employ a smaller domain-specific generative AI model alongside a larger general-purpose model. In such a case, the server first uses the smaller model to perform coarse-grained classification of the user concern and then passes a narrowed prompt sentence to the larger model for fine-grained keyword extraction and explanation generation, thereby improving computational efficiency.

In another variation, the server precomputes, for each information item, a set of latent features or prototype prompt sentences that describe typical user concerns for which the item is appropriate. The server encodes these prototype prompt sentences using the generative AI model or a related encoder, and stores the resulting vectors in the information storage device. When a new user prompt sentence is received, the server compares its encoded vector with these stored vectors to identify candidates. This approach further reduces the dimensionality and complexity of on-the-fly search operations.

In yet another embodiment, the terminal performs part of the normalization or feature extraction processing, such as basic tokenization or language detection, before sending the prompt sentence to the server. This offloads computation from the server and can reduce processing time in distributed deployments. However, the server still performs the core normalization, generative analysis, search condition generation, and recommendation formatting, ensuring that the technical improvements described above are consistently realized on the server side.

Through these embodiments and variations, the server, terminal, and generative AI model cooperate in a structured manner, using specific data structures, algorithmic steps, and model architectures to implement an improved computer-implemented recommendation system. The system increases speed, precision, and explainability of recommendation processing, enhances data management and monitoring, and reduces computation and communication overhead, thereby providing concrete improvements in the functioning of the underlying computer technology.

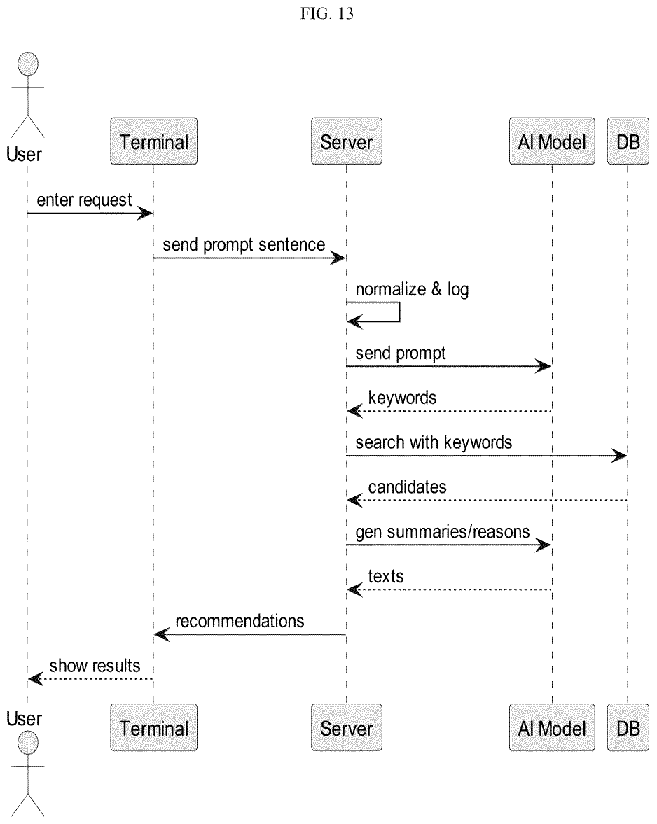

The following describes the processing flow using FIG. 13.

### Step 1

The user operates the terminal to input a natural language request.

The terminal displays an input field and a prompt sentence such as:

“Please enter the concern or request you currently have.

Example: I am struggling with human relationships at work and feel stressed every day.”

Input: The user provides a free-form text string describing a concern or request (candidate prompt sentence).

Processing: The terminal accepts keystrokes or touch input, updates the on-screen text area in real time, and waits until the user activates a submit control (e.g., a “Send” button).

Output: The terminal holds the completed natural language text in a local data structure as a prompt sentence ready to be transmitted to the server.

### Step 2

The terminal constructs a transmission object and sends the prompt sentence to the server.

Input: The terminal uses the locally stored prompt sentence and possibly local metadata (e.g., device ID, language setting).

Processing: The terminal encapsulates the prompt sentence into a request object, sets protocol headers, and establishes a secure connection to the server using a network stack (e.g., TCP/IP with TLS). The terminal serializes the request object into a message body and transmits the message through the communication interface.

Output: The server receives a network message containing the prompt sentence as application-layer data.

### Step 3

The server receives and decodes the message from the terminal.

Input: The server obtains a network packet stream containing the serialized request object, including the prompt sentence.

Processing: The server's communication module reconstructs the application message from packets, parses protocol headers, and extracts the message body. The server then deserializes the body to retrieve the prompt sentence string and any associated metadata. The server verifies message integrity, checks that the prompt sentence is present and non-empty, and discards malformed requests.

Output: The server stores the prompt sentence and metadata as in-memory variables suitable for further processing.

### Step 4

The server performs normalization and logging of the prompt sentence.

Input: The server uses the raw prompt sentence string and associated metadata from Step 3.

Processing: The server applies normalization procedures, such as converting the character encoding to UTF-8, trimming spaces, unifying line breaks, and normalizing punctuation. The server optionally performs language detection and applies language-specific normalization rules. The server then generates a unique request identifier and obtains a timestamp. The server writes a record to a storage device containing the request identifier, the original prompt sentence, the normalized prompt sentence, the timestamp, and anonymized user information.

Output: The server produces a normalized prompt sentence stored in memory and a persistent log record stored in the storage device.

### Step 5

The server constructs a prompt sentence for the generative AI model.

Input: The server uses the normalized prompt sentence from Step 4.

Processing: The server loads a template for a generative AI model input, which includes a system instruction and a user instruction. The server inserts the normalized prompt sentence into a predefined position, for example:

“You are an assistant that analyzes user concerns and extracts key topics for database search.

User's concern: [normalized prompt sentence]
1. Extract 3-7 important keywords about the user's concern.
2. Output only a JSON array of strings.”

The server may also attach control parameters such as maximum output length or language constraints.

Output: The server produces a complete model-specific prompt sentence (or message set) stored as a structured object ready to be supplied to the generative AI model.

### Step 6

The server encodes the constructed prompt sentence and sends it to the generative AI model.

Input: The server uses the model-specific prompt sentence from Step 5.

Processing: The server segments the text into tokens using the vocabulary and tokenization rules of the generative AI model. The server converts each token to a numerical identifier and arranges these identifiers into a sequence. The server packages the token sequence and control parameters into a request object compatible with the generative AI model interface, and transmits this object to the model, either via a local function call (for an internal model) or via a network API (for an external model).

Output: The generative AI model receives a numerical representation of the prompt sentence and associated parameters.

### Step 7

The generative AI model performs internal inference and returns analysis result data.

Input: The generative AI model uses the token sequence and control parameters from Step 6.

Processing: The generative AI model propagates the token sequence through an embedding layer, multiple self-attention layers, and feed-forward layers. The model computes context-aware vector representations and then generates output token probabilities step by step, selecting output tokens according to a decoding algorithm such as greedy decoding or sampling with temperature control. The model forms an output token sequence representing a JSON array of keywords.

Output: The generative AI model returns a generated text string, which encodes analysis result data including keyword information, to the server.

### Step 8

The server receives and validates the analysis result data from the generative AI model.

Input: The server obtains the generated text string returned by the generative AI model in Step 7.

Processing: The server decodes the token sequence into characters, reconstructing the text. The server then attempts to parse the text as a JSON array. If the parse succeeds, the server verifies that each element is a string and optionally checks constraints such as maximum keyword length. If the parse fails or the structure is invalid, the server applies a recovery procedure, such as trimming extraneous text or re-issuing a refined prompt sentence with stricter format instructions to the model.

Output: The server produces a validated list of keyword strings representing keyword information derived from the user's prompt sentence.

### Step 9

The server constructs search conditions from the keyword information.

Input: The server uses the list of keyword strings from Step 8.

Processing: The server assigns a weight to each keyword based on factors such as rarity, position in the prompt sentence, or semantic specificity. The server builds a structured query object that includes conditions for matching keywords against title fields, description fields, and tag fields of stored information items, as well as vector similarity thresholds when vector representations are available. The server may also add filter criteria derived from user metadata, such as language or region.

Output: The server creates one or more search condition objects encapsulating all constraints needed to query the information storage device or search processing mechanism.

### Step 10

The server executes search processing over the information storage device using the search conditions.

Input: The server uses the search condition objects from Step 9 and accesses an information storage device that stores multiple information items.

Processing: The server submits keyword-based subqueries and vector-based subqueries to the search processing mechanism. The search processing mechanism computes lexical relevance scores (e.g., term frequency-inverse document frequency) and vector similarity scores (e.g., cosine similarity) between the keywords and stored feature vectors of information items. The search processing mechanism retrieves matching records and returns a ranked list of related information candidates with associated scores.

Output: The server receives a set of related information candidates, each including item identifiers, fields such as title and description, and relevance scores.

### Step 11

The server evaluates and filters the related information candidates.

Input: The server uses the list of related information candidates and their relevance scores from Step 10.

Processing: The server computes a composite relevance score for each candidate by combining search scores with additional factors, such as past interaction statistics or system-defined preferences. The server eliminates candidates that fail to meet a minimum score threshold or violate explicit exclusion rules. The server may apply a diversity algorithm that reduces the score of items too similar to higher-ranked items, thus improving variety.

Output: The server produces a refined list of recommendation information candidates, each with an adjusted relevance score and item metadata.

### Step 12

The server generates summary descriptions and recommendation reasons using the generative AI model.

Input: The server uses the refined list of recommendation information candidates from Step 11 and the normalized prompt sentence from Step 4.

Processing: For each candidate, the server constructs a new prompt sentence for the generative AI model, for example:

“You are an assistant that generates concise recommendations.

User's concern: [normalized prompt sentence]

Item: Title: [item title], Description: [item description].

Generate:
1. A short summary in 2-3 sentences.
2. A one-sentence explanation of why this item is suitable for the user's concern.”

The server replaces the placeholders with actual values. The server sends these prompt sentences to the generative AI model, receives generated summaries and explanations, and optionally applies post-processing rules, such as truncating overly long text or removing disallowed content.

Output: The server obtains, for each selected item, a summary description string and a recommendation reason string aligned with the user's concern.

### Step 13

The server assembles an output data structure containing the recommendation information.

Input: The server uses the selected items from Step 11 and the generated summaries and recommendation reasons from Step 12.

Processing: The server creates a structured object for each item, storing fields such as title, summary description, recommendation reason, and reference identification information (e.g., a link or identifier). The server aggregates these item objects into a list and wraps the list in a higher-level response object that can be serialized for transmission. The server may sort the items by final relevance score before assembly.

Output: The server produces a finalized output data structure that represents all recommendation information in a format suitable for the terminal.

### Step 14

The server transmits the output data structure to the terminal.

Input: The server uses the output data structure created in Step 13.

Processing: The server serializes the data structure into a response message and assigns appropriate protocol headers. The server sends the message through the communication interface to the terminal over the communication line. The server logs the response metadata linked to the original request identifier for future analysis.

Output: The terminal receives a message that encodes the structured recommendation information.

### Step 15

The terminal decodes and presents the recommendation information to the user.

Input: The terminal uses the received message containing the output data structure from Step 14.

Processing: The terminal deserializes the message body to reconstruct the list of recommendation items. The terminal generates user interface components for each item, including display areas for titles, summary descriptions, and recommendation reasons, as well as interactive controls linked to the reference identification information. The terminal adapts layout and style according to device characteristics, such as screen size and orientation.

Output: The user sees the recommendation information displayed on the terminal and can interact with the items, for example by selecting a link to view additional details.

### Step 16

The user reviews the recommendation information and optionally performs a follow-up action.

Input: The user observes the presented titles, summaries, and explanations on the terminal from Step 15.

Processing: The user may compare items, decide which recommendation is most helpful, and activate a control associated with a chosen item. The user's interactions generate new events on the terminal, such as button presses or link activations.

Output: The terminal records user interaction events and may initiate additional actions, such as opening a detailed resource or sending interaction logs back to the server for further analysis.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In conventional recommendation systems that utilize machine learning or artificial intelligence, several technical problems arise in the end-to-end processing pipeline from user input to presentation of actionable recommendation results.

First, existing systems often treat user input as a simple text string and pass it directly to a generative AI model without structured analysis. As a result, the system fails to extract predicate-argument structure, important terms, and emotional state from the input, and the generated output tends to be noisy, ambiguously scoped, or poorly aligned with the user's actual intent. This leads to increased post-processing complexity and reduces the usability and reliability of the overall computer-implemented recommendation pipeline.

Second, many systems are not architected to transform the free-form output text of a generative AI model into structured, machine-processable data that can be programmatically linked to external information services. The output of the generative AI model is typically presented as unstructured text to the user without further enrichment. Consequently, it is technically difficult for the system to automatically associate the generated recommendations with authoritative external data sources, such as catalog databases, and to attach purchase or access links in a consistent, robust way. This limitation prevents the system from providing recommendation results in a format that can directly drive downstream transactional or retrieval operations.

Third, even where external data sources are available, conventional architectures usually do not provide a unified mechanism for querying multiple heterogeneous external information services based on the content of the generative AI model output, and for integrating returned metadata with the generated recommendations. This leads to fragmented processing flows in which different content types (for example, books and music) require separate, ad hoc implementations, increasing development complexity and reducing maintainability and scalability of the computer system.

Fourth, typical systems do not effectively incorporate an automatically inferred emotional state of the user into the construction of the prompt sentence supplied to the generative AI model. As a result, the recommendation logic is unable to systematically adapt to the user's current affective context. From a technical perspective, this means that the natural language processing pipeline and the generative model interface are loosely coupled and do not exploit emotion estimation outputs, resulting in suboptimal use of computational resources and inferior alignment between system output and user needs.

Accordingly, there is a need for an improved computer-implemented system and processing architecture in which a processor: (i) performs structured natural language analysis of user input to extract feature information including predicate-argument structure, important terms, and emotional state; (ii) generates an explicit prompt sentence that encodes these features as an instruction to a generative AI model; (iii) converts the unstructured response text from the generative AI model into structured data; (iv) queries external information services to acquire detailed metadata and acquisition connection information for each recommendation candidate; and (v) integrates all of this information into recommendation result data that can be directly used by the user to purchase or access recommended resources. Such an architecture improves the technical functioning of the recommendation system as a whole by enhancing the precision, structure, and transactional readiness of the generated output.

The specific processing by the specific processing unit 290 of the data processing device 12 in Application Example 2 is realized by the following means.

The present invention provides a server comprising a processor configured to provide an information input/output interface that receives input information expressed in natural language from a user, perform character string processing and natural language processing to extract feature information including predicate-argument structures, important terms, and an expressed emotional state, generate based on the feature information and the input information a prompt sentence including an instruction statement for causing a generative artificial intelligence model to recommend an information resource or an entertainment content, transmit the prompt sentence to the generative artificial intelligence model operating on an external computing resource and receive a response text including one or more recommendation candidates, analyze the response text to generate structured data for each recommendation candidate, perform queries to one or more external information providing services based on the structured data to acquire detailed information and acquisition connection information corresponding to each recommendation candidate, and integrate the detailed information and the acquisition connection information with the structured data to generate recommendation result data in a format in which the user is enabled to purchase or use the recommendation candidates and present the recommendation result data to the user via the information input/output interface. This enables the server to improve the operation of the computer-implemented recommendation pipeline by systematically converting unstructured user input and generative artificial intelligence output into structured, enriched recommendation result data linked to external information services, thereby enhancing the accuracy, contextual relevance, and direct usability of recommendations within the computing environment.

The term “system” refers to a combination of one or more computing devices, hardware components, and software components that cooperate to execute the claimed processing, including at least a processor and associated memory, interfaces, and communication functions.

The term “processor” refers to one or more hardware processing units, such as a central processing unit or other instruction execution circuitry, configured to execute program code to perform the functions recited in the claims.

The term “information input/output interface” refers to hardware and software components that enable exchange of information between the system and a user or another device, including graphical user interfaces, application programming interfaces, network interfaces, and input devices.

The term “user” refers to a human operator or an entity that provides input information to the system and receives recommendation result data from the system.

The term “input information” refers to data that is received by the system from a user or another component, including at least natural-language text expressing a need, request, concern, or emotion.

The term “natural language” refers to a human language used for everyday communication, including sentences, phrases, and words that can be processed by natural language processing techniques.

The term “communication path” refers to a logical or physical channel over which data is transmitted between the system and another device or service, including wired and wireless networks.

The term “character string processing” refers to operations performed on sequences of characters, including at least tokenization, normalization, filtering, and pattern matching.

The term “natural language processing” refers to computational techniques for analyzing, interpreting, and transforming text expressed in a natural language, including at least tokenization, part-of-speech tagging, syntactic analysis, semantic analysis, and entity recognition.

The term “feature information” refers to structured data derived from input information via processing by the system, including predicate-argument structures, important terms, and an expressed emotional state.

The term “predicate-argument structure” refers to a representation of a clause or sentence that identifies a main predicate, such as a verb, and one or more associated arguments, such as subjects, objects, and complements.

The term “important terms” refers to words, phrases, or expressions extracted from input information that are determined by the system to be relevant for recommendation, such as domain keywords and named entities.

The term “emotional state” refers to an affective condition inferred from input information, such as a mood or feeling, including examples such as sadness, stress, relaxation, or desire for encouragement.

The term “prompt sentence” refers to a constructed text string that includes instructions and contextual information for a generative artificial intelligence model to perform a specified task, such as generating recommendations.

The term “instruction statement” refers to a portion of a prompt sentence that explicitly directs the generative artificial intelligence model to perform a particular processing operation, such as recommending resources.

The term “generative artificial intelligence model” refers to a machine-implemented model configured to generate output data, including natural-language text, in response to input data, using learned parameters derived from training on data sets.

The term “information resource” refers to digital or physical content that provides information to a user, including at least publications, documents, and reference materials.

The term “entertainment content” refers to content intended primarily for entertainment, including at least audio works, video works, interactive works, and cultural works.

The term “external computing resource” refers to a computing environment separate from the local processor, such as a remote server or cloud computing infrastructure, that executes the generative artificial intelligence model.

The term “communication protocol” refers to a defined set of rules and formats used for exchanging data between the system and an external computing resource.

The term “response text” refers to text data generated by the generative artificial intelligence model and returned to the system in response to a prompt sentence.

The term “recommendation candidate” refers to an individual item of information resource or entertainment content that is identified by the generative artificial intelligence model as a potential recommendation.

The term “structured data” refers to data organized in a predefined format, such as records or objects that include named fields, enabling deterministic, programmatic access and processing.

The term “title information” refers to data that represents a name or title associated with a recommendation candidate, such as the title of a work.

The term “creator information” refers to data that represents a person or entity responsible for creating or producing a recommendation candidate, such as an author, artist, or producer.

The term “description information” refers to data that provides a summary or explanation of a recommendation candidate, such as an abstract, synopsis, or short commentary.

The term “external information storage device” refers to a data storage component or system external to the processor, such as a remote database or repository, that stores information related to recommendation candidates.

The term “information providing service” refers to a network-accessible service that responds to queries by providing information about items, such as catalog entries, metadata, and links.

The term “detailed information” refers to metadata obtained from an external information storage device or information providing service that supplements the basic identification of a recommendation candidate, including attributes such as description, classification, pricing, or publication data.

The term “acquisition connection information” refers to data that enables a user device to access, obtain, or purchase a recommendation candidate, such as a network address, uniform resource locator, or other access identifier.

The term “recommendation result data” refers to data generated by the system that aggregates structured data, detailed information, and acquisition connection information for one or more recommendation candidates in a form suitable for presentation to a user.

The term “emotion estimation model” refers to a computational model that receives input information, such as natural-language text, and outputs an estimated emotional state, such as an emotion label and its intensity.

The term “emotion label” refers to a symbolic representation of an emotional state, such as a categorical identifier indicating a type of emotion.

The term “intensity of the emotion label” refers to a numerical or ordinal value indicating the strength or degree of a corresponding emotion label.

The term “content type” refers to a classification of a recommendation candidate according to its medium or category, such as a publication type, audio type, or video type.

The term “external information providing services” refers to two or more information providing services that may be heterogeneous in terms of data formats, access methods, or content domains, and that are queried by the system based on output of the generative artificial intelligence model.

In one or more embodiments, a server, a terminal, and a user cooperate to implement the claimed system such that the processor of the server executes a concrete software architecture on specific hardware resources. The following description illustrates exemplary embodiments that support and enable implementation of the claimed invention.

### A. Hardware and Software Configuration

A server uses one or more physical computing machines, for example, a rack-mount computer or a virtual machine instance provided by a data center platform. The server includes at least one central processing unit, a main memory, a non-volatile storage device, and a network interface controller. The server executes an operating system such as a general-purpose server operating system and a runtime environment for an application layer, for example a web framework.

The server executes application software including:
a web application module implemented using a server-side framework such as a lightweight HTTP framework;
a natural language processing module implemented using a natural language processing library such as a statistical or neural library comparable to spaCy or a toolkit comparable to NLTK;
an emotion estimation module implemented using a numerical computation framework comparable to TensorFlow or similar, configured to run a trained neural network;
a generative AI client module configured to call a generative AI model via an external application programming interface;
an external information service client module configured to call catalog-type web services comparable to book information services or music information services;
a recommendation integration module configured to combine outputs from the generative AI model and the external information services.

A terminal uses a computing device carried or operated by the user, such as a smartphone, a tablet computer, or a personal computer. The terminal includes at least a processor, memory, a display unit, a user input device such as a touchscreen, and a network communication unit. The terminal executes an application such as a web browser or a native application that communicates with the server via a network using, for example, an HTTPS protocol.

A user operates the terminal, provides natural-language input, and views recommendation results displayed by the terminal.

### B. Data Structures and Internal Modules

A server stores and uses multiple internal data structures to implement the claimed functions. For example, the server stores:
a user request object that includes fields for raw text, language code, timestamp, a session identifier, and optional user profile attributes;
a feature vector object that includes lists of tokens, part-of-speech tags, dependency relations, extracted important terms, and an emotional state representation;
a prompt sentence object that includes a natural-language instruction string and associated metadata such as target content type and generation parameters;
a model response object that stores the raw text returned by the generative AI model;
a recommendation item object that includes title information, creator information, description information, a content type field, and one or more acquisition connection information fields.

The natural language processing module of the server uses a parsing engine comparable to spaCy that loads a language model into memory. The language model contains parameter matrices for token embedding, part-of-speech tagging, and dependency parsing. When a user request arrives, the server instantiates a user request object and passes the raw text to the parsing engine. The parsing engine generates a sequence of tokens, each token storing text, lemma, part-of-speech, and dependency relation. From this sequence, the server generates predicate-argument structures by identifying verbs and associated subject and object relations. The server extracts important terms by applying scoring functions such as term frequency-inverse document frequency or attention-based importance weights.

The emotion estimation module uses a neural network such as a multi-layer recurrent network or a transformer-based classifier. The network includes an embedding layer that converts tokens to dense vectors, one or more hidden layers that aggregate context representations (for example, bidirectional recurrent layers or self-attention layers), and a final classification layer that outputs probabilities over a fixed set of emotion labels. The network parameters are stored in the server's non-volatile storage and are loaded into memory at runtime.

During training (performed offline), the server uses a labeled corpus of text segments and associated emotion labels. The server defines a loss function such as cross-entropy between predicted emotion distributions and ground-truth labels, and updates network weights using a gradient-based optimizer such as stochastic gradient descent or Adam. The server may apply regularization techniques such as dropout and data augmentation techniques such as synonym replacement to improve robustness. This training process results in a trained emotion estimation model that infers emotion labels and intensities from new user input with improved accuracy and reduced variance compared to naive heuristics.

The generative AI client module of the server communicates with a generative AI model using an external API. The generative AI model is a neural network with an autoregressive transformer architecture, including multiple layers of multi-head self-attention and feed-forward sublayers, trained on a large corpus of text using a language modeling objective that minimizes the negative log likelihood of tokens given preceding context. The generative AI model is hosted on an external computing resource, such as a cloud-based accelerator platform, and returns text completions for given prompt sentences.

The external information service client module of the server defines request templates for catalog-type web services that respond to queries with structured metadata. The module formats search queries including title information and creator information and parses responses into an internal metadata representation, which is stored in recommendation item objects.

### C. Construction of the Prompt Sentence and Interaction with the Generative AI Model

A server uses the feature vector object and the emotion estimation output to construct a prompt sentence that is more specific, structured, and machine-useful than the user's original text. The server applies rule-based templates that incorporate:
the user's original input text;
extracted important terms;
inferred content type (e.g., information resource or entertainment content);
inferred emotional state of the user.

For example, when a user enters “I am struggling with relationships at work.” the server constructs the following prompt sentence:

“The user says: ‘I am struggling with relationships at work.’

Keywords: work, relationships, communication.

Please recommend several practical books that help improve workplace human relationships and communication.

For each book, output the title and a one-sentence description.”

When the user enters “Recently I am very tired from work and want to relax.” the server constructs another prompt sentence:

“The user's concern is: ‘Recently I am very tired from work and want to relax.’

Detected emotion: stressed.

Please recommend relaxing music albums or playlists, and briefly explain why they are suitable for relieving work-related fatigue.”

By encoding the predicate-argument structure and the emotional state within the prompt sentence, the server constrains the generative AI model to produce output in a structured, expectation-aware format, thereby reducing irrelevant or malformed outputs. This design improves computational efficiency because the downstream parsing and external service lookup can rely on a more predictable output structure, which simplifies parsing algorithms and reduces error handling overhead.

A server, via the generative AI client module, sends the prompt sentence to the generative AI model, with parameters such as maximum token length and sampling temperature set to values chosen to balance diversity and determinism of recommendations. The generative AI model generates a response text that may include a numbered list of recommendations. The server receives the response text and stores it in a model response object.

### D. Conversion of Model Output to Structured Data and Integration with External Services

A server analyzes the response text using a deterministic parsing algorithm. For example, the server identifies list item markers such as numerals followed by punctuation, and splits the response text into segments. For each segment, the server applies regular expressions and pattern recognition rules to separate the title information from explanatory text. If the generative AI model tends to generate titles in quotation marks or preceding a dash, the server identifies titles using such non-human-intuitive syntactic conventions that are specifically adapted to the model's output style.

To handle ambiguity, the server uses the previously extracted important terms and content type classification to verify that a parsed segment corresponds to the expected domain (for example, a book domain or a music domain). If a segment does not meet minimal domain criteria, the server discards it as noise, improving precision of the final recommendation list.

A server then uses the external information service client module to send queries to catalog-type services. For books, the server constructs a query string that includes the parsed title information and, if present, part of the creator information. The server sends an HTTP request and receives a response structured in a representation such as a tree-like document. The server extracts fields such as official title, authors, description, and acquisition connection information such as a purchase link. For music, the server uses a similar approach with a music catalog service. The server also may store commonly requested metadata in a local cache, organized as a key-value store indexed by normalized title identifiers, which reduces repeated network calls and thus reduces network latency and communication load.

### E. Generation and Presentation of Recommendation Result Data

A server constructs recommendation item objects for each successful external lookup, populating fields including title information, creator information, description information, content type, and acquisition connection information. The server assembles a list of recommendation items into recommendation result data. The server may order the list by a score that combines multiple factors, such as similarity between item metadata and extracted important terms, emotion compatibility, and historical usage patterns. This scoring function is implemented as a numeric computation that yields better ranking stability compared to simple lexicographic ordering.

A terminal receives the recommendation result data via a network connection and renders it as graphical components. Each component includes visible title information, a textual description, and a selectable control linked to the acquisition connection information. When the user activates such a control, the terminal initiates a network request to access the external acquisition location, such as a content platform. In this way, the recommendation result data directly drives a technical interaction with external information systems, not merely a presentation of abstract advice.

### F. Technical Effects and Improvement of Computer Technology

The described configuration yields several technical improvements over conventional systems.

First, by using structured parsing of user input to extract predicate-argument structures and important terms and by encoding these within a prompt sentence, the server shapes the input to the generative AI model into a machine-optimized representation. This reduces the entropy of the input space, which in turn decreases the variance of the model's output and reduces the range of possible malformed outputs. As a consequence, the server can implement simpler and faster post-processing logic, improving overall processing speed and reducing computational overhead for parsing and error correction.

Second, by integrating an emotion estimation model into the prompt sentence construction, the server adapts the generative AI model's operation to an internal state of the user that is not explicitly encoded in the raw text. This yields outputs that are more context-appropriate and reduces the need for repeated requests or additional interactive clarification. From a technical standpoint, fewer interaction cycles correspond to fewer network transmissions and fewer calls to the generative AI service, thereby reducing network load and processing resource consumption at both the server and the external computing resource.

Third, by systematically converting the generative AI output into structured data and aligning it with external information services through deterministic keys such as title information and creator information, the server enhances the interoperability of human-language outputs with machine-oriented catalog data. This conversion is not a simple human-like reading of text, but a defined sequence of machine parsing steps and external lookup operations that produce recommendation result data that is directly actionable by other software systems. The result is improved data management and more reliable linkages between generative AI output and authoritative reference data sources.

Fourth, the neural network architectures used for emotion estimation and for the generative AI model are configured and trained using specific training objectives and optimization techniques. For example, the emotion estimation network uses cross-entropy loss and gradient-based weight updates on vector representations of tokens. These operations are executed at machine speed and exploit vectorized instructions and optimized numerical routines, achieving classification accuracy and throughput that are infeasible with manual rule-based systems or human analysis. This contributes to an improvement of the underlying computer technology in terms of classification precision and latency.

Fifth, the described pipeline implements non-conventional coordination between multiple AI components and external services: the server does not merely automate a human expert's recommendation behavior, but combines (i) structured extraction of predicate-argument structures and emotion, (ii) engineered prompt sentence templates tailored for a generative AI model, and (iii) deterministic integration with external metadata services to produce results in a transactional format. This composite architecture improves the functioning of the computer system itself by enabling it to efficiently resolve ambiguities, manage heterogeneous external data sources, and produce stable and machine-interpretable recommendation artifacts.

### G. Alternative Embodiments and Variations

A server may support multiple content types beyond books and music, such as video, interactive media, or educational materials. In such cases, the feature extraction and prompt sentence construction modules apply content-type-specific templates and scoring rules. The same overall architecture remains applicable: the server analyzes user input, constructs a content-appropriate prompt sentence, obtains a response from the generative AI model, parses it into structured data, and integrates it with external information services.

A server may deploy different emotion estimation models, such as convolutional neural networks or transformer-based encoders, depending on available training data and performance requirements. The server may also adapt the set of emotion labels and intensity scales to support fine-grained control over recommendation behavior. For example, the server may distinguish between “acute stress” and “chronic stress” categories, using different prompt sentence templates and external metadata filters.

A server may implement caching and prefetching strategies for external service queries. When the generative AI model generates a known popular title, the server can retrieve associated metadata from a local cache rather than repeating an external request. This reduces external network traffic and improves response time. The server may maintain indexing structures, such as hash tables keyed by normalized titles, to accelerate cache lookup.

A terminal may be implemented as a native application that uses a custom communication protocol on top of standard transport layers. The terminal may store some recommendation result data locally, enabling offline viewing of previous results and deferring external acquisition operations until connectivity is restored.

A user may provide additional optional input, such as preferred media types or constraints like budget or availability, via the terminal's user interface. The server may incorporate this information into the feature extraction and prompt sentence construction process, thereby further refining the generative AI model's output and the subsequent external lookup operations.

Through these embodiments and variations, the system provides an implementation that a person skilled in the art can realize by using known computing hardware and software frameworks, while exploiting the specific data structures, processing sequence, and integrated AI and external-service interactions described above to achieve the technical effects associated with the claimed invention.

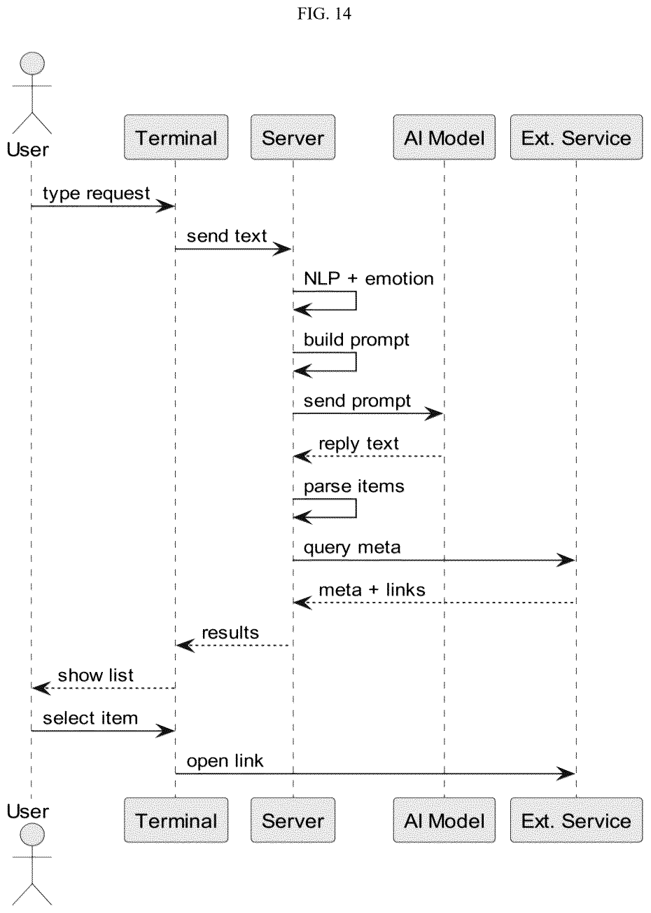

The following describes the processing flow using FIG. 14.

### Step 1

User operates the terminal to input a natural-language request.

User views an input screen on the terminal and types a free-form text such as “I am struggling with relationships at work.” or “Recently I am very tired from work and want to relax.”.

Input: raw natural-language text from the user, plus optional user profile and session context.

Output: a structured request payload on the terminal containing the text, a language code, a timestamp, and a session identifier.

Terminal validates that the text is non-empty and within a predefined maximum length, then serializes the payload (for example, to JSON) and sends it to the server over a secure network connection.

### Step 2

Server receives and normalizes the user request.

Server accepts the network request via a web framework endpoint and parses the payload to extract the text, language code, timestamp, and session identifier.

Input: serialized request payload from the terminal.

Output: an internal user request object containing normalized text and metadata.

Server converts the character encoding to a canonical format (for example, UTF-8), trims leading and trailing whitespace, and logs the request with a unique request identifier for traceability.

### Step 3

Server performs basic natural-language preprocessing.

Server passes the normalized text to a natural-language processing module and invokes tokenization, part-of-speech tagging, and dependency parsing.

Input: user request object with raw text.

Output: a feature vector object containing tokens, lemmas, part-of-speech tags, dependency relations, and candidate important terms.

Server executes numerical routines of the NLP library, which map each token to internal identifiers and compute syntactic relations, then applies scoring rules (for example, term frequency or position-based weighting) to mark important terms such as “work”, “relationships”, or “relax”.

### Step 4

Server derives predicate-argument structures and domain cues.

Server analyzes the dependency relations to identify main verbs and their subjects and objects, constructing predicate-argument structures like “struggle(user, relationships at work)”.

Input: feature vector object with syntactic annotations.

Output: an enriched feature vector object that includes predicate-argument structures and domain cues (for example, workplace context, fatigue context).

Server evaluates patterns such as verb types and prepositional phrases and maps them to domain tags such as “workplace human relationships” or “stress and relaxation”.

### Step 5

Server estimates the user's emotional state.

Server feeds the tokenized text into an emotion estimation model (for example, a neural classifier) that outputs probabilities over a set of emotion labels.

Input: token sequence and embeddings derived from the user's text.

Output: an emotion label (for example, “stressed”, “sad”, “wants encouragement”) and an intensity score.

Server executes forward propagation through the network layers, computes scores at the output layer, selects the label with the highest probability, and stores both the label and intensity in the feature vector object.

### Step 6

Server determines the target content type and recommendation intent.

Server combines domain cues, important terms, and optional user preferences to decide whether the system should recommend books, music, video, or other content.

Input: enriched feature vector object containing domain tags, important terms, and emotion data.

Output: a content type classification (for example, “books” or “music”) and a recommendation intent descriptor.

Server applies a rule set or a lightweight classifier that maps recognized patterns (for example, “read”, “book”, or workplace issues) to a book domain, and patterns like “relax”, “listen” to a music domain.

### Step 7

Server constructs a prompt sentence for the generative AI model.

Server selects a template based on the content type and recommendation intent and fills the template using the original text, important terms, and emotion label.

Input: original user text, important terms, content type classification, and emotion label/intensity.

Output: a prompt sentence string suitable for a generative AI model.

Server concatenates structured segments to form instructions such as:

“The user says: ‘I am struggling with relationships at work.’

Keywords: work, relationships, communication.

Please recommend several practical books that help improve workplace human relationships and communication.

For each book, output the title and a one-sentence description.”

or

“The user's concern is: ‘Recently I am very tired from work and want to relax.’

Detected emotion: stressed.

Please recommend relaxing music albums or playlists, and briefly explain why they are suitable for relieving work-related fatigue.”

### Step 8

Server sends the prompt sentence to the generative AI model and requests recommendations.

Server constructs an API request that includes the prompt sentence and generation parameters and transmits it to the generative AI model hosted on an external computing resource.

Input: prompt sentence and generation parameters (for example, maximum tokens, temperature).

Output: a response text from the generative AI model describing recommendation candidates.

Server performs a network call via a defined protocol, waits for the model to generate the response, and then stores the returned text into a model response object together with the request identifier.

### Step 9

Server parses the response text into candidate recommendation items.

Server analyzes the response text line by line and identifies list items, titles, and descriptions using pattern detection and regular expressions.

Input: model response object containing the raw response text.

Output: a preliminary list of candidate items, each with extracted title text and description text.

Server detects markers such as numbered lists, quotation marks, or separators and splits each item into a title region and an explanation region, discarding segments that do not satisfy minimal structural criteria (for example, missing title length).

### Step 10

Server queries external information services to obtain authoritative metadata.

Server iterates over each candidate item and constructs search queries for catalog-type services based on the extracted title and, if available, creator hints from the description.

Input: preliminary candidate list containing title strings and descriptions.

Output: a set of metadata records corresponding to matched items from external services, including detailed attributes and acquisition links.

Server sends search requests to external services, receives structured responses, and parses fields such as official titles, creators, descriptions, classification, and purchase or access URLs, then maps those fields into internal metadata structures.

### Step 11

Server integrates model-generated data with external metadata and generates structured recommendation items.

Server merges the preliminary candidate items with the authoritative metadata records, resolving duplicates and inconsistencies.

Input: preliminary candidate list and external metadata records.

Output: a refined list of recommendation item objects containing title information, creator information, description information, content type, and acquisition connection information.

Server aligns items based on matching titles or identifiers, attaches the corresponding metadata, enriches descriptions if necessary, and discards candidates for which no reliable external match is found.

### Step 12

Server assembles recommendation result data for presentation.

Server packages the refined recommendation item objects into a response payload, optionally ordering them according to a relevance or emotion-compatibility score.

Input: refined list of recommendation item objects and optional scoring metrics.

Output: recommendation result data formatted for transmission to the terminal.

Server computes scores based on similarity between items and extracted important terms and on compatibility with the emotion label, sorts the list accordingly, and serializes the result into a structured response.

### Step 13

Terminal receives and renders the recommendation result data.

Terminal accepts the response payload from the server and constructs visual components for each recommendation item.

Input: serialized recommendation result data from the server.

Output: a displayed recommendation list on the terminal screen, with interactive controls linked to acquisition connection information.

Terminal parses the payload, creates user interface elements showing the title, short description, and a button or link labeled, for example, “Buy” or “Listen”, and binds each control to the corresponding acquisition URL.

### Step 14

User selects a recommended item and initiates acquisition or access.

User reviews the displayed list and activates a control associated with a selected item.

Input: displayed recommendation list and user's selection action (for example, a tap or click).

Output: a navigation or network request from the terminal to the acquisition connection destination.

Terminal captures the selection event, retrieves the associated acquisition connection information from the recommendation item, and opens a browser view or dedicated client to access the external service where the user can purchase or use the recommended content.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

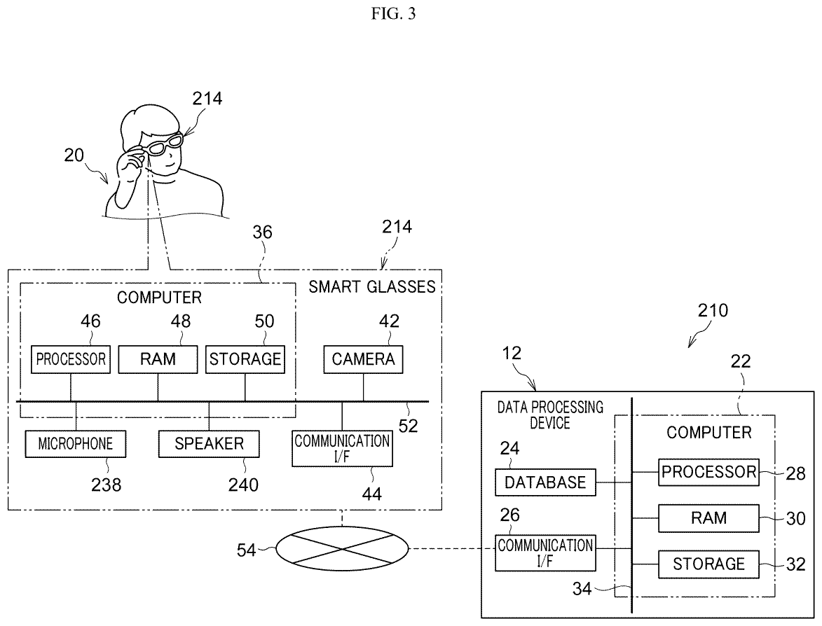

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

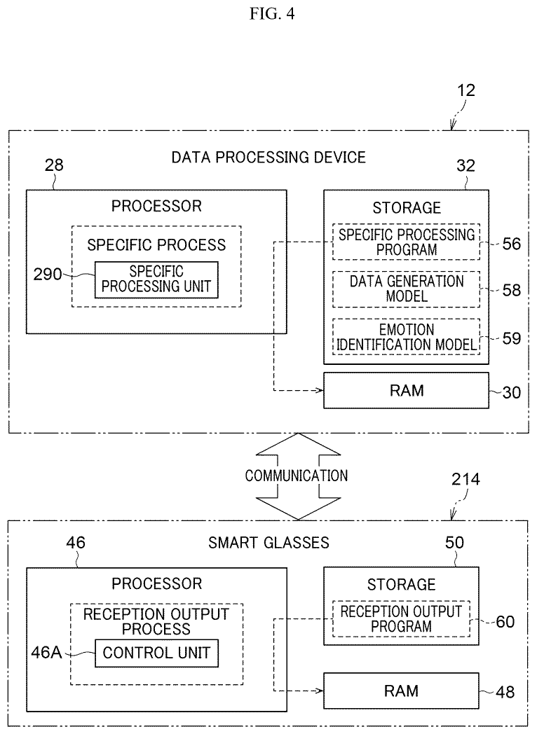

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

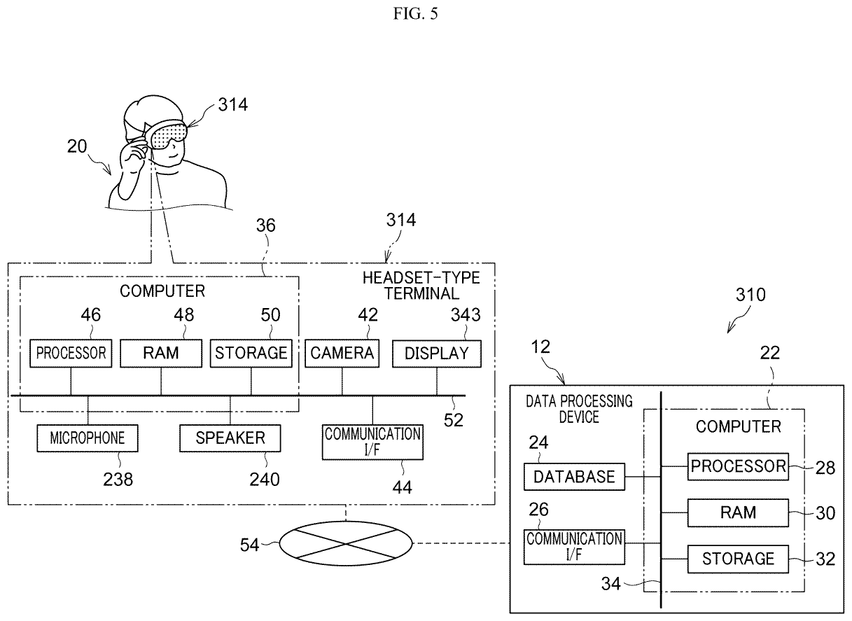

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

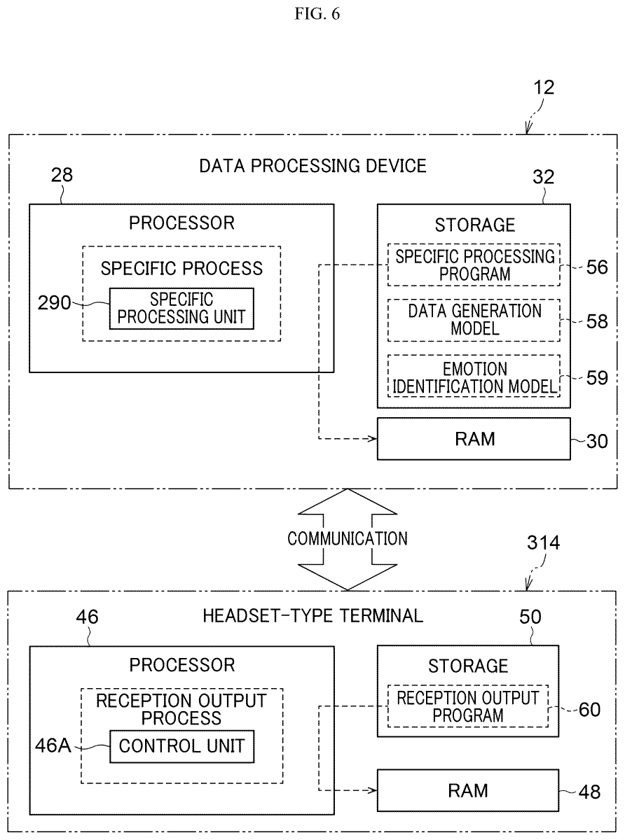

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

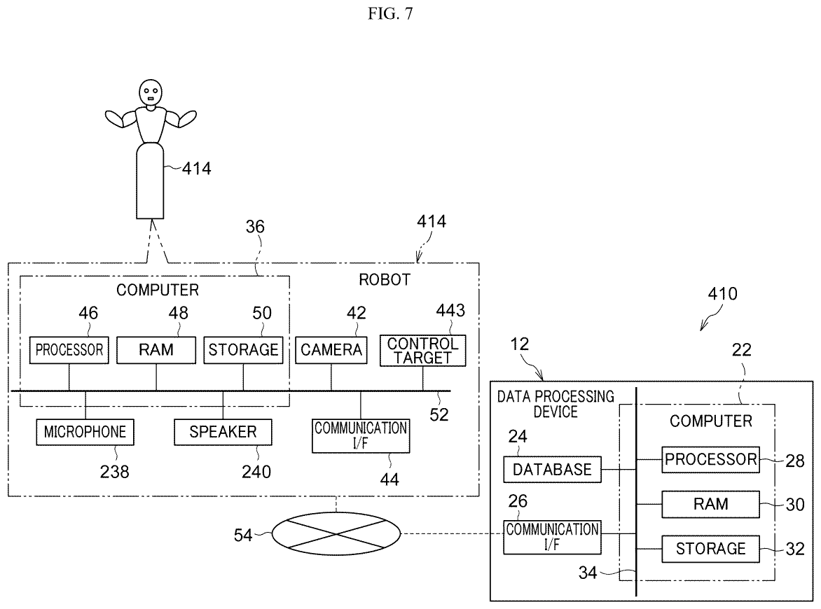

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

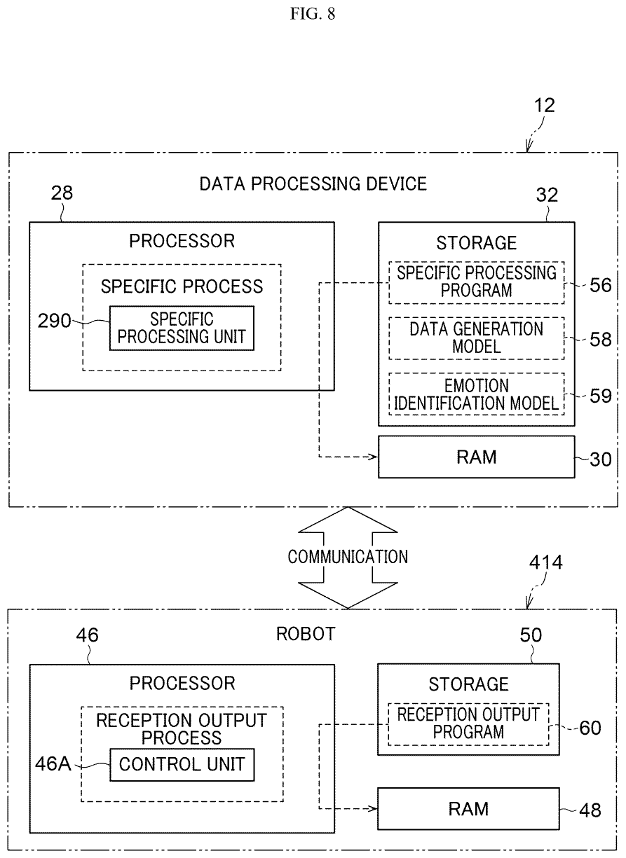

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

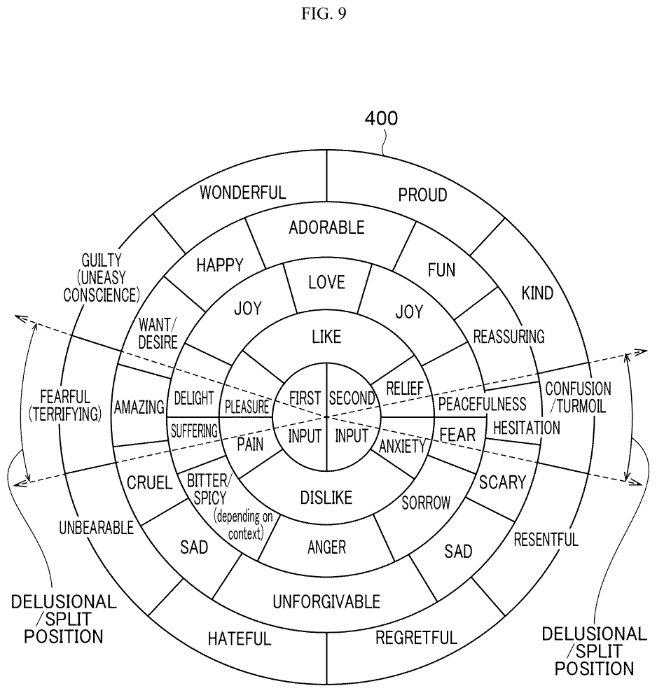

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

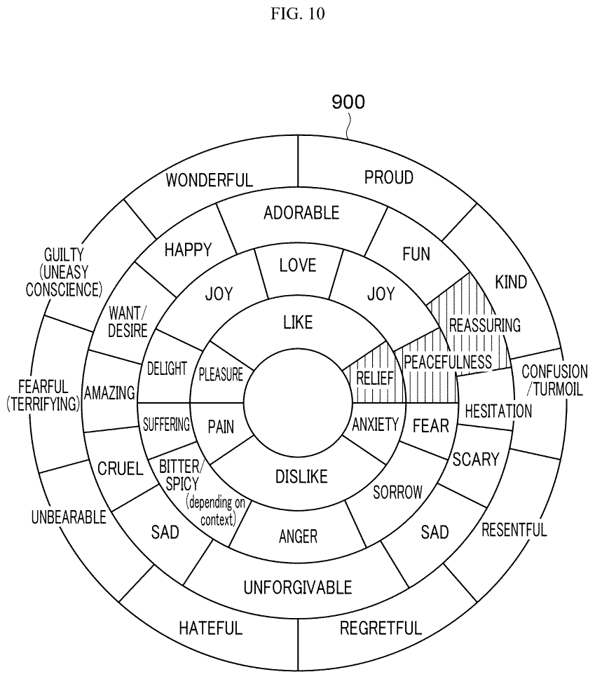

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
provide, on an information processing apparatus, an input/output screen serving as an interface for obtaining a concrete request from a user, and acquire the request as character information input through the input/output screen; and
analyze the acquired character information by using a natural language processing algorithm to generate abstract attribute information indicating a target domain, preference attributes, and constraint conditions included in the request, and construct a prompt sentence that defines instruction content, an output format, and a number of recommendations for a generative AI model on the basis of the abstract attribute information; and
execute communication processing for inputting the constructed prompt sentence to the generative AI model, and receive response text regarding candidate recommendations from the generative AI model; and
analyze the received response text to extract name information and creator information of each candidate recommendation, and obtain, by collating an extraction result with a response result from an external information providing apparatus, identification information and reference location information corresponding to each candidate recommendation; and
generate recommendation result information including connection information that enables the user to acquire or use the candidate recommendations on the basis of the identification information and the reference location information, and present the recommendation result information to the user via the input/output screen.

### Supplementary 2

The system according to Supplementary 1,
wherein the processor is configured to
cause the natural language processing algorithm to analyze data relating to a music preference of the user based on voice information or character information of the user, generate abstract attribute information indicating a genre, a mood, a usage scene, a time period, and a usage medium, and construct, based on the abstract attribute information, the prompt sentence that instructs the generative AI model to perform recommendation of audio content.

### Supplementary 3

The system according to Supplementary 1,
wherein the processor is configured to
cause the natural language processing algorithm to analyze information relating to a psychological state or an issue of the user, generate abstract attribute information indicating a subject, a field, a difficulty level, and a usage purpose, and construct, based on the abstract attribute information, the prompt sentence that instructs the generative AI model to perform recommendation of document content.

### Application Example 1

### Supplementary 1

A system comprising a processor,
wherein the processor is configured to provide an input/output interface for receiving, from a user terminal, concrete requests in natural language regarding cultural content,
wherein the processor is configured to generate, based on the received concrete requests, a prompt sentence in natural language, to construct query data including the prompt sentence, and to transmit the query data to a generative AI model executed on an information processing resource,
wherein the processor is configured to receive, from the generative AI model, a recommendation result including a list of cultural content items, and to analyze the recommendation result to extract individual cultural content items,
wherein the processor is configured to search, for each of the extracted cultural content items, one or more content distribution platforms on which viewing or acquisition of the cultural content items is available, by using at least one external information processing device or storage device,
wherein the processor is configured to generate association information that associates each of the cultural content items with at least one of the content distribution platforms, and to append, to the association information, reference information including access identification information enabling access to the content distribution platforms,
and wherein the processor is configured to transmit the association information and the reference information to the user terminal as a recommendation result displayable on the user terminal.

### Supplementary 2

The system according to supplementary 1,
wherein the processor is configured to analyze information regarding preferences of the user for audio content, and to generate, based on an analysis result, a prompt sentence in natural language that instructs the generative AI model to recommend audio content.

### Supplementary 3

The system according to supplementary 1,
wherein the processor is configured to analyze information regarding psychological or lifestyle concerns of the user, and to generate, based on an analysis result, a prompt sentence in natural language that instructs the generative AI model to recommend textual content.

### Example 2

### Supplementary 1

A system comprising a processor,
wherein the processor is configured to
provide, on a terminal, an information input/output interface for receiving a concrete request expressed in natural language from a user, and to acquire, via a communication line from the terminal, a prompt sentence including the request,
normalize the acquired prompt sentence as analysis target data, store the normalized prompt sentence in a storage device in association with log-management information, and construct a message for converting the prompt sentence into an input format for a generative information processing model,
transmit the message to an internal or external generative information processing model, cause the generative information processing model to execute natural language processing, and acquire analysis result data including keyword information related to the request,
extract the keyword information from the acquired analysis result data, generate search conditions for a plurality of information items stored in an information storage device on the basis of the keyword information, and cause the information storage device or a search processing mechanism to execute a search process in accordance with the search conditions to acquire related information candidates,
perform relevance evaluation computation and filtering processing on the acquired related information candidates, select recommendation information that matches contents of the request of the user, and format the recommendation information as an output data structure including a summary description, a recommendation reason, and reference identification information, and
transmit the formatted output data structure to the terminal and cause the terminal to present the recommendation information such that the recommendation information is displayable or operable on the terminal.

### Supplementary 2

The system according to supplementary 1,
wherein the processor is configured to input, to the generative information processing model, an additional prompt sentence including the request and attribute information of search target items, cause the generative information processing model to generate, for each piece of the recommendation information, the summary description and the recommendation reason, and generate the output data structure using a generation result from the generative information processing model.

### Supplementary 3

The system according to supplementary 1,
wherein the processor is configured to search, on the basis of the keyword information extracted from the prompt sentence relating to a concern of the user, the plurality of information items including document information, product information, and service information stored in the information storage device, and select the recommendation information as solution candidates corresponding to the concern.

### Application Example 2

### Supplementary 1

A system comprising a processor,
wherein the processor is configured to
provide an information input/output interface that receives input information expressed in natural language from a user and receives the input information via a communication path,
perform character string processing and natural language processing on the input information to extract feature information including predicate-argument structures, important terms, and an expressed emotional state, and generate, based on the feature information and the input information, a prompt sentence including an instruction statement for causing a generative artificial intelligence model to recommend an information resource or an entertainment content,
transmit the generated prompt sentence, by using a communication protocol, to the generative artificial intelligence model operating on an external computing resource, and receive, from the generative artificial intelligence model, a response text including one or more recommendation candidates generated in response to the prompt sentence,
analyze the response text and generate structured data including, for each recommendation candidate, title information, creator information, and description information,
perform a query to an external information storage device or an information providing service based on the title information and the creator information included in the structured data, and
acquire detailed information and acquisition connection information corresponding to each recommendation candidate, and
associate and integrate the detailed information and the acquisition connection information with the structured data, generate recommendation result data in a format in which the user is enabled to purchase or use the recommendation candidates, and present the recommendation result data to the user via the information input/output interface.

### Supplementary 2

The system according to supplementary 1,
wherein the processor is configured to
use, in the natural language processing, an emotion estimation model that estimates an emotional state from the input information of the user to calculate an emotion label and an intensity of the emotion label, and include the emotion label and the intensity of the emotion label in the prompt sentence so as to adapt recommendation content by the generative artificial intelligence model to the emotional state of the user.

### Supplementary 3

The system according to supplementary 1,
wherein the processor is configured to
analyze the response text received from the generative artificial intelligence model, perform a search query to a plurality of types of external information providing services including at least one book information providing service and one music information providing service based on title information extracted from the response text, acquire detailed information and acquisition connection information corresponding to a content type, and present, to the user, recommendation result data organized for each content type.

What is claimed is:

1. A system comprising:
circuitry configured to:
receive, via a communication interface coupled to a packet-switched network, character information representing a request from a terminal device, and analyze the character information using a natural language processing algorithm to generate abstract attribute information indicating a target domain, preference attributes, and constraint conditions included in the request;
construct, based on the abstract attribute information, a prompt sentence that defines instruction content, an output format, and a number of candidate recommendations for a generative neural network model, and transmit the prompt sentence to the generative neural network model via the communication interface to receive response text comprising candidate recommendation information;
analyze the received response text to extract name information and creator information of each candidate recommendation, and obtain, by collating an extraction result with a response result from an external information providing apparatus accessed via the communication interface, identification information and reference location information corresponding to each candidate recommendation; and
generate recommendation result information comprising connection information that enables a user to acquire or use the candidate recommendations, based on the identification information and the reference location information, and transmit the recommendation result information to the terminal device via the communication interface.

2. The system according to claim 1, wherein the circuitry is configured to analyze data relating to a preference of the user based on at least one of voice information or character information received from the terminal device, generate abstract attribute information indicating a genre, a mood, a usage scene, a time period, and a usage medium, and construct the prompt sentence to instruct the generative neural network model to perform recommendation of audio content based on the abstract attribute information.

3. The system according to claim 2, wherein the circuitry is configured to apply a preference weighting function to the abstract attribute information, assigning higher weights to attributes derived from the voice information than to attributes derived from the character information, and to incorporate the weighted attributes into the prompt sentence.

4. The system according to claim 2, wherein the circuitry is configured to store the abstract attribute information in the storage device as a user preference profile, and to update the user preference profile upon receiving new character information or voice information from the terminal device to enable iterative refinement of subsequent prompt sentences.

5. The system according to claim 1, wherein the circuitry is configured to analyze information relating to a psychological state or an issue of the user, generate abstract attribute information indicating a subject, a field, a difficulty level, and a usage purpose, and construct the prompt sentence to instruct the generative neural network model to perform recommendation of document content based on the abstract attribute information.

6. The system according to claim 5, wherein the circuitry is configured to apply a content filtering function to the recommendation result information to exclude document content associated with difficulty levels exceeding a threshold derived from the constraint conditions, and to transmit a filtered recommendation result to the terminal device.

7. The system according to claim 1, wherein the circuitry is configured to store the recommendation result information in a storage device in association with session identification data, and to retrieve stored recommendation result information in response to a continuation request received from the terminal device via the communication interface.

8. The system according to claim 7, wherein the circuitry is configured to detect a modification instruction included in the continuation request, update the abstract attribute information based on the modification instruction, reconstruct the prompt sentence, and retransmit the updated prompt sentence to the generative neural network model to obtain updated response text.

9. The system according to claim 8, wherein the circuitry is configured to compare the updated response text against the previously stored recommendation result information to identify newly added candidate recommendations and removed candidate recommendations, and to transmit a differential recommendation result to the terminal device.

10. The system according to claim 1, wherein the circuitry is configured to generate, based on the abstract attribute information, a plurality of prompt sentences each defining a different output format or a different number of recommendations, transmit each of the plurality of prompt sentences to the generative neural network model, and merge the received response texts into a unified candidate recommendation set prior to performing the collating.

11. The system according to claim 10, wherein the circuitry is configured to apply a deduplication function to the unified candidate recommendation set to identify and remove duplicate entries based on the name information and creator information, and to rank remaining candidates by an occurrence frequency prior to generating the recommendation result information.

12. The system according to claim 1, wherein the circuitry is configured to apply a validation function to the identification information obtained by the collating to verify that the reference location information resolves to an accessible resource, and to exclude from the recommendation result information any candidate recommendation for which the reference location information fails the validation.

13. The system according to claim 12, wherein the circuitry is configured to substitute, for each excluded candidate recommendation, an alternative candidate recommendation obtained by querying the external information providing apparatus with updated collation parameters derived from the name information and creator information of the excluded candidate.

14. The system according to claim 1, wherein the circuitry is configured to receive feedback data from the terminal device indicating a user evaluation of one or more candidate recommendations included in the recommendation result information, store the feedback data in the storage device in association with the abstract attribute information, and use the feedback data to adjust the abstract attribute information in a subsequent request processing cycle.

15. The system according to claim 14, wherein the circuitry is configured to compute an update vector from the feedback data and to apply the update vector to a preference model stored in the storage device to refine the natural language processing algorithm's generation of abstract attribute information for subsequent requests from the terminal device.

16. The system according to claim 1, wherein the circuitry is configured to apply a natural language processing function to the response text to detect inconsistencies between the extracted name information or creator information and the abstract attribute information, and to generate a corrected prompt sentence incorporating the detected inconsistencies as additional constraint conditions when inconsistencies are found.

17. The system according to claim 16, wherein the circuitry is configured to limit the number of corrected prompt sentence regeneration cycles to a maximum threshold, and to transmit a partial recommendation result comprising only successfully collated candidate recommendations to the terminal device when the maximum threshold is reached.

18. A system comprising:
circuitry configured to:
receive, via a communication interface coupled to a packet-switched network, character information representing a request from a terminal device, and apply a natural language processing algorithm to the character information to generate abstract attribute information indicating a target domain, preference attributes, and constraint conditions;
construct a prompt sentence defining instruction content, an output format, and a number of candidate recommendations based on the abstract attribute information, transmit the prompt sentence to a generative neural network model via the communication interface, and receive response text comprising candidate recommendation information from the generative neural network model;
extract name information and creator information from the response text, collate the extracted information against a response from an external information providing apparatus accessed via the communication interface to obtain identification information and reference location information, and apply a validation function to verify that the reference location information resolves to an accessible resource; and
generate recommendation result information comprising connection information based on validated identification information and reference location information, store the recommendation result information in a storage device in association with session identification data, and transmit the recommendation result information to the terminal device via the communication interface.

19. The system according to claim 18, wherein the circuitry is configured to receive feedback data from the terminal device indicating a user evaluation of one or more candidate recommendations, store the feedback data in the storage device, and apply the feedback data to adjust the abstract attribute information in a subsequent request processing cycle.

20. A method comprising:
receiving, via a communication interface coupled to a packet-switched network, character information representing a request from a terminal device, and analyzing the character information using a natural language processing algorithm to generate abstract attribute information indicating a target domain, preference attributes, and constraint conditions included in the request;
constructing, based on the abstract attribute information, a prompt sentence that defines instruction content, an output format, and a number of candidate recommendations for a generative neural network model, and transmitting the prompt sentence to the generative neural network model via the communication interface to receive response text comprising candidate recommendation information;
analyzing the received response text to extract name information and creator information of each candidate recommendation, and obtaining, by collating an extraction result with a response result from an external information providing apparatus, identification information and reference location information corresponding to each candidate recommendation; and
generating recommendation result information comprising connection information that enables a user to acquire or use the candidate recommendations, based on the identification information and the reference location information, and transmitting the recommendation result information to the terminal device via the communication interface.
